(19) United States
(12) Patent Application Publication
(10) Pub. No.: US 2026/0192587 A1
(43) Pub. Date: Jul. 9, 2026

(54) METHOD AND SYSTEM FOR PRODUCING TINTED OPTICAL COATINGS

(71) Applicant: FLO OPTICS LTD., Petach Tikva (IL)

(72) Inventors: Ilan HIDANA, Katzir (IL); Claudio ROTTMAN SAVION, Petach Tikva (IL); Tamir CHARTARIFSKY, Hod Hasharon (IL)

(21) Appl. No.: 19/551,670

(22) Filed: Feb. 27, 2026

Related U.S. Application Data
(63) Continuation of application No. PCT/IB2024/058531, filed on Sep. 2, 2024.
(60) Provisional application No. 63/580,003, filed on Sep. 1, 2023.
(60) Provisional application No. 63/541,279, filed on Sep. 28, 2023.
(60) Provisional application No. 63/541,292, filed on Sep. 28, 2023.
(60) Provisional application No. 63/541,293, filed on Sep. 28, 2023.

(30) Foreign Application Priority Data
Jul. 8, 2024 (GB) 2409920.2
Jul. 9, 2024 (GB) 2409979.8

(51) Int. Cl. B41M 3/00; B41J 3/407; B41J 11/00; B41M 5/00; B41M 7/00; C09D 11/037; C09D 11/54; G02B 1/14

(52) U.S. Cl. CPC B41M 3/003; B41J 3/4073; B41J 11/002; B41J 11/008; B41M 5/0017; B41M 5/0041; B41M 5/0082; B41M 7/009; C09D 11/037; C09D 11/54; G02B 1/14

(57) ABSTRACT

Methods and systems for producing an optical construction on a optical substrate, one such method including: (a) microvalving drops of a liquid, dye-containing formulation onto an optical surface of the optical substrate, to form a wet continuous layer; and (b) treating the wet layer to produce a continuous, dried dye containing layer on the optical surface, wherein the optical surface is a curved surface, and wherein the optical surface is a polymeric surface.

### CROSS-REFERENCE TO OTHER PUBLICATIONS

This application is a continuation of PCT/IB2024/058531, filed on Sep. 2, 2024, which is incorporated by reference herein in its entirety. PCT/IB2024/058531 claims priority from US patent application nos. 63/580,003, filed on Sep. 1, 2023; 63/541,293, filed on Sep. 28, 2023; 63/541,279, filed on Sep. 28, 2023; 63/541,292, filed on Sep. 28, 2023; as well as from GB application nos. 2409920.2, filed on Jul. 8, 2024, and GB2409979.8, filed on Jul. 9, 2024; the teachings of all of which are incorporated herein by reference.

### FIELD AND BACKGROUND OF THE INVENTION

The present invention relates to optical and ophthalmic devices and articles having tinted coatings, and to methods and systems for applying and forming such coatings on these devices and articles.

Commercial, high-throughput production of eyeglass coatings is often performed using various analog coating process such as dipping and spin coating processes.

Ultra-thin anti-reflective coatings having a thickness of 200 to 300 nanometers may be applied, layer-by-layer, by means of vacuum deposition.

In various known processes, optical impediments may be appreciably exacerbated when the target surface is a curved optical surface such as an eyeglass lens, and particularly, for eyeglass lenses having high SAG numbers or base curves.

The present inventors have recognized a need for improved optical and ophthalmic devices and articles having tinted coatings, and for systems and methods of producing such devices and articles.

### SUMMARY OF THE INVENTION

According to some teachings of the present invention there is provided a method of producing an optical construction on an optical substrate, the method comprising: (a) microvalving ink drops of an ink formulation containing at least one dissolved dye onto an optical surface of the optical substrate, to form a wet layer; and (b) treating the wet layer to produce a dried dye-containing layer on said optical surface.

Other aspects of the invention are disclosed hereinbelow.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 provides a schematic block diagram of a method of treating an optical surface, according to aspects of the present invention;

FIG. 2 provides a schematic block diagram of a method of treating an optical surface to produce a tinted optical layer or coating, according to aspects of the present invention;

FIG. 3 provides optional steps for the schematic block diagram of FIG. 2, in which the pre-treatment may include the applying of a liquid primer formulation to the exposed surface of the ophthalmic substrate, along with subsequent drying/curing;

FIG. 4 is a schematic cross-sectional view of a multi-layered ophthalmic structure, which includes an ophthalmic substrate having a tinted, ophthalmic construction fixedly attached to a broad surface of the substrate;

FIGS. 4A and 4B are schematic representations of a microvalve apparatus jetting ink drops onto a convex lens surface and onto a concave lens surface, respectively;

FIG. 5 shows a conceptual representation of a process for coating and finishing an optical or ophthalmic substrate using a coating system, according to embodiments of the present invention;

FIGS. 6A, 6B and 6C show respective block diagrams of exemplary coating systems according to embodiments of the present invention;

FIGS. 7A and 7B show respective conceptual representations of a process for coating an optical or ophthalmic substrate using a coating system in conjunction with a surface treatment apparatus, according to embodiments of the present invention;

FIG. 8 shows a block diagram of an exemplary coating system according to embodiments of the present invention;

FIG. 9 shows a block diagram of an exemplary surface treatment apparatus according to embodiments of the present invention;

FIGS. 10A, 10B, 10C and 11 show respective conceptual representations of processes for coating and drying an optical or ophthalmic substrate, according to embodiments of the present invention;

FIGS. 12A, 12B, 12C and 12D show respective schematic views of exemplary optical substrates according to embodiments of the present invention;

FIGS. 13A and 13B show respective side and perspective schematic views of a virtual two-dimensional projection of a curved surface of an optical substrate according to embodiments of the present invention;

FIG. 14 shows a schematic side view of drop deposition on a curved surface of an optical substrate in accordance with a virtual two-dimension projection of the surface, according to embodiments of the present invention;

FIG. 15 shows a schematic top view of an optical substrate including a virtual annulus comprising an edge portion according to embodiments of the present invention; and

FIG. 16 shows a schematic side view of an optical substrate having a curved surface, showing certain aspects of the surface geometry according to embodiments of the present invention.

### DESCRIPTION OF THE PREFERRED EMBODIMENTS

The principles and operation of the optical constructions according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The inventors have found that applying one or more optical coatings to an optical substrate involves a variety of technological hurdles. Some of these relate to optical substrates, which tend to be highly smooth, and substantially non-absorbent. Optical substrates are generally transparent, and may require a high degree of transparency from the plurality of optical coatings. Moreover, the refractive index of each coating, or of all the coatings together, may be constrained to be similar to that of the optical substrate.

The optical construction or article produced must satisfy mechanical criteria such as hardness and/or scratch resistance. Each of the coatings must also be relatively inert to the other coatings in contact therewith. Moreover, since the coatings may be applied successively, at least one of the applied wet, or uncured, formulations may contact, and interact with, a previously applied coating.

The curing time of each coating or layer should be reasonable (at most minutes or hours), and the curing temperature should be sufficiently low so as not to damage the optical substrate, nor to damage any previously applied coatings.

The adhesion to the optical or ophthalmic substrate and resistance to peeling or cracking of the coating or coatings may also be crucial to obtaining a viable coated lens such as a coated ophthalmic lens.

From a throughput standpoint, it would be advantageous to apply very large ink drops (e.g., on the order of nanoliters, and not picoliters) on such curved, smooth eyeglass surfaces.

The inventors have found, however, that such large ink drops—even with precise digital application—disadvantageously detract from image resolution.

Moreover, ink drops tend to slip on such curved, smooth eyeglass surfaces, particularly in the case of low-viscosity ink drops. Such uncontrolled flow may make the ultimate positioning of the drops decidedly non-deterministic. This problem is exacerbated for large, nanoliter-size (e.g., having a volume of 10 nanoliters) drops: relative to picoliter-size drops, which have about 1/1000 the volume, as the volume to surface area of the nanoliter-size ink drop is manifestly high, as is the volume of the drop to the contact area of the deposited drop. Consequently, the inventors have found that various surface-based fixation means (e.g., an adhesive underlayer) may be of limited efficacy, such that the deposition of such nanoliter-size drops may disadvantageously produce a non-continuous or at least non-even wet layer, resulting in bald spots, haze, uneven thickness, uneven optical density, and other optical impediments in the finished product.

While spinning, rotating, etc., have been contemplated in attempts to produce smooth and even wet layers, the inventors have found that such methods fail to meet various technological challenges, and may add significant technological disadvantages of their own, particularly within the framework of industrial settings.

It would thus be highly desirable to produce ophthalmic-quality, thin, continuous, smooth wet layers, without employing these methods. For colored layers and coatings, it would be further desirable for the optical density to be even, at least as discernable by the naked eye.

It will be appreciated that for highly curved lens surfaces (e.g., base curve 4, base curve 6 or higher), the problem of uncontrolled flow becomes even more severe, particularly for large lens diameters.

Moreover, the inventors have further found that in the production of ultra-thin (e.g., having a dry thickness of at most 2 μm, at most 1.6 μm, or at most 1.2 μm) optical coatings, the potential for optical impediments in the finished product may be yet further pronounced.

Without wishing to be limited by theory, the inventors believe that the microvalving of a continuous, relatively smooth and even layer of dye-containing ink on an optical surface (and more particularly, on a curved optical surface such as an eyeglass lens) may be effected by achieving the conditions of “controlled flow” of the ink on the optical surface. When the ink drops are microvalved on the optical surface without fixation means (e.g., when the solvent is predominantly a low evaporation rate solvent), the applied dye-containing ink may disadvantageously flow in a substantially uncontrolled fashion, which may result in at least one of flooding, bald spots, coffee ring type effects, uneven layer thickness, and uneven color intensity within the layer. Moreover, by covering the entire surface of the substrate with ink drops, the flooding phenomenon may appreciably worsen. However, when the ink drops are quickly and heavily fixated on the optical surface (e.g., when the solvent is predominantly a very-high evaporation rate solvent), the dye-containing layer may not be continuous, or even if continuous, may lack the requisite smoothness and evenness required for optical and ophthalmic layers and coatings.

The inventors have found that by balancing the solvent system with a particular mixture of relatively low and high evaporation rate solvents, a degree of controlled flow may be achieved, which surprisingly may result in a layer having the requisite smoothness and evenness required for optical and ophthalmic layers or coatings such as tinted layers or coatings.

Methods and systems for achieving such controlled flow are provided hereinbelow.

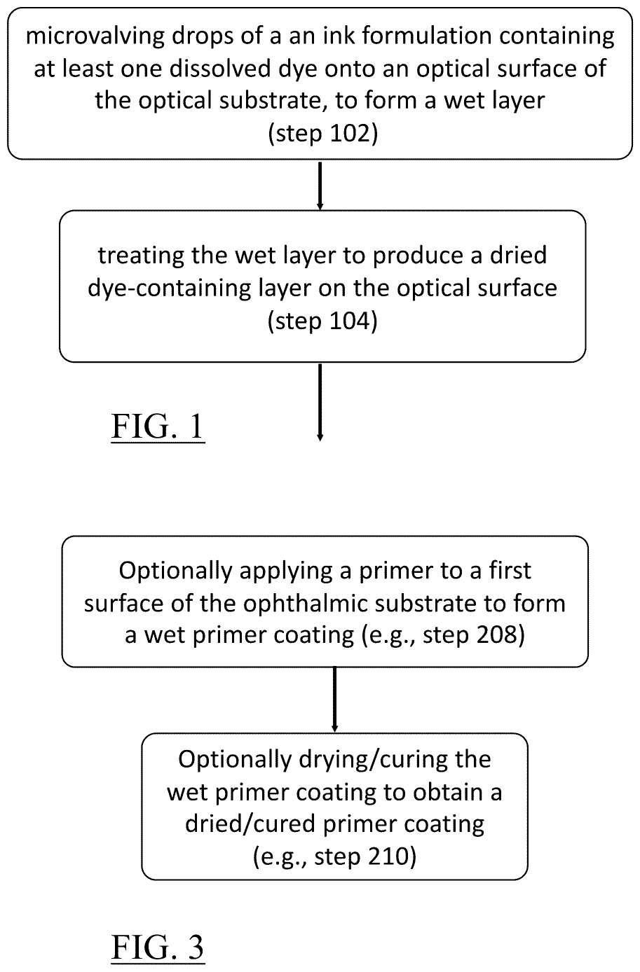

As schematically presented in FIG. 1, the inventive method includes microvalving (i.e., jetting via a microvalve) drops of a liquid, dye containing formulation onto an optical surface of an optical substrate, to form a wet layer (step 102).

The microvalving of the ink formulation onto the optical/ophthalmic substrate may be performed utilizing various microvalving technologies, all of which utilize a microvalve.

The microvalve may be a component within a microvalve system, and several microvalves can be utilized, preferably in parallel, to improve throughput.

Typically, the microvalving of the photochromatic formulation is performed according to a pre-determined pattern such as a pre-determined digital pattern.

In some embodiments, the microvalve is piezo-actuated (e.g., using a Nordson Pulse Jet Valve, a Vermes MDS 1560 Series, or a Techcon 9800 series);

In some embodiments, the microvalve is electromagnetically actuated (e.g., using a solenoid valve). The fluid or dispersion flows through the microvalve directly. When a current is applied through the valve coil, a mobile anchor attached to a valve ball is magnetically pulled by the magnetic field of a stationary anchor. The microvalve opens, discharging a portion of the medium. When no current is applied, the microvalve is closed, as a closing spring acts on the mobile anchor associated with the valve ball.

Exemplary microvalves of this type are manufactured by Fritz Gyger AG and by the Lee company.

In some embodiments, the microvalve is electro-pneumatically actuated. Exemplary microvalves of this type are the Liquidyn® P-Jet Series, manufactured by Nordson.

In some embodiments, the optical surface is a curved optical surface such as a curved lens surface.

In some embodiments, the optical surface is a polymeric surface.

In some embodiments, the optical substrate is an ophthalmic substrate, and the optical surface is an ophthalmic surface.

In some embodiments, the ophthalmic substrate is a prescription lens such as an eyeglass lens.

The term “ophthalmic substrate”, as used herein, refers to a substrate that is used by the human eye to view therethrough. The ophthalmic substrate is a component of an ophthalmic device or system, or an ophthalmic component of such a device or system. Typically, the ophthalmic substrate is a lens, and the ophthalmic surface is a surface of the lens.

More generally, the term “ophthalmic”, as used herein to modify a structure, such as a “substrate”, “surface”, “construction”, “structure”, “device”, “arrangement”, and “system”, refers to the property of that structure that enables the human eye to effectively view an object therethrough. While a coated lens is a typical example of an ophthalmic device, other applications will be appreciated by those of skill in the art, including, by way of example, a helmet having a transparent visor.

An ophthalmic construction may consist of, or include, an ophthalmic component of such an ophthalmic device or system.

With regard to the wet ink layer, at least one of a thickness TH, characteristic thickness THc, and average thickness THav of the wet ink layer (and typically any two or all three of TH, THc, and THav) is at most 100 micrometers (μm), or at most 80 μm, and more typically, at most 70 μm, at most 60 μm, or at most 50 μm.

Typically, at least one of TH, THc, and THav (and typically any two or all three of TH, THc, and THav) is at least 10 μm, at least 14 μm, at least 18 μm, at least 25 μm, at least 30 μm, at least 40 μm, or at least 45 μm.

The method may further comprise treating the wet layer to produce a dried tint or dye-containing layer on the optical surface (step 104). The treating includes drying and/or curing the wet layer. The nature of the formulation may largely determine the preferred method of curing.

Thus, in some embodiments, the drying/curing (formation of a film) is essentially or solely effective by drying (solvent evaporation), e.g., when the polymer is dissolved (e.g., vinyl ester resins or alkyd resins in organic solvent) or dispersed (e.g., aqueous dispersions such as PUDs), or in the form of an emulsion (e.g., styrene-acrylic emulsion polymers). Such drying is typically conducted at elevated temperatures (“thermal drying”).

In some embodiments, the drying/curing is effected by chemical drying/curing (e.g., polymerization from pre-polymers—monomers and oligomers; cross-linking of polymers, oxidative chemical curing, e.g., using ambient oxygen; cationic or radical curing, e.g., using UV radiation; oxidative chemical curing, e.g., using ambient oxygen; moisture-scavenging chemical curing, e.g., using ambient humidity).

In some embodiments, the chemical drying/curing is or includes curing by actinic radiation, i.e., by electromagnetic radiation (e.g., UV radiation, electron beam, IR, and microwave) that is capable of initiating a chemical reaction.

The drying/curing of the wet layer may advantageously be performed so as to achieve a “fully cured” layer or coating. The inventors have found that partially cured layers may result in solvent attack, migration, mixing, etc. from an adjacent or subsequently-applied layer in the stack. These phenomena may appreciably detract from optical quality.

In addition, and with particular reference to solvent attack, the penetration of solvent from a subsequently applied layer may compromise the adhesion at the interface between these layers, and at the interface between the two previously applied layers, or between the previously applied layer and the substrate. Thus, fully curing of the wet layer may be cardinal in producing an optical stack or construction having both suitable optical and mechanical properties.

Significantly, the inventors have found that solvent systems containing both high and low evaporation rate solvents may appreciably mitigate the extent of solvent penetration, when such penetration cannot be completely avoided.

Further methods of producing high-quality optical stacks will be evident from the description below.

As used herein in the specification and in the claims section that follows, the term “SAGITTA”, or “SAG”, with reference refers to the convex or concave curvature of an optical substrate, represents the physical distance between the vertex (the highest point of the convex curvature) along the curved surface of the optical substrate and the center point of a line drawn perpendicular to the curved surface from one edge of the optical substrate to the other. The SAG may be measured, or determined according to the following established equation:

$$SAG = \vert R \vert - \sqrt{{R}^{2} - {( \frac{D}{2} )}^{2}}$$

wherein R is the radius of curvature of the optical surface and D is the diameter thereof.

In some embodiments, the SAG number of the optical substrate is at least 0.5 mm, at least 1 mm, at least 2 mm, at least 3.5 mm, at least 5 mm, or at least 6 mm.

Typically, the SAG number of the optical substrate is at most 15 mm, at most 13.5 mm, at most 12 mm, or at most 10.5 mm.

The base curve of the optical substrate may be at least 2, at least 3, at least 4, at least 5, at least 6, or at least 8.

The base curve may be at most 14, and more typically, at most 12 or at most 10. At higher base curves and SAG numbers, the flow of ink on the optical surface may be sufficiently uncontrolled as to compromise the optical quality of the layer or coating.

As used herein, the term “base curve” refers to the theoretical base curve, or “true curve”.

Similarly, the phenomenon of uncontrolled flow may also be correlated with the peripheral tangential angle α (discussed in further detail hereinbelow) of the lens. The methods of the present invention are generally suitable for controlling flow on the lens for peripheral tangential angles of up to 37°, up to 42°, or even up to 50°.

In some embodiments, the ink formulation (tint) may comprise a resin, a dye, and a solvent system including a very low vapor-pressure solvent (LLevap) and at least one of a low vapor-pressure solvent (Levap), a medium vapor-pressure solvent (Mevap), a high vapor-pressure solvent (Hevap) and a very high vapor-pressure solvent (HHevap), wherein the resin and the tint dye are dissolved within the solvent system.

In some embodiments, the ink formulation may contain or further contain at least one photochromic dye, dissolved within the solvent system.

Such an ink formulation may contain a softening agent for softening the resin. Typically, the softening agent forms a single liquid phase with the solvent system, the resin, any tint dye, and the photochromic dye. Such an ink formulation is typically solvent-based.

The softening agent includes a liquid softening agent. Typically, the liquid softening agent is, includes, or consists essentially of a non-volatile liquid softening agent.

In some embodiments, the softening agent further includes a solid softening agent such as a solid polymeric softening agent.

In some embodiments, the ink formulation is an ophthalmic formulation.

In some embodiments, the ink formulation is suitable for forming an ophthalmic film on an ophthalmic substrate.

In some embodiments, the resin is an ophthalmic, film-forming resin.

In some embodiments, the non-volatile content of the ink formulation is within a range of 2.5 to 15%.

In some embodiments, the ink formulation may comprise a soluble dye and a solvent system including a very low vapor-pressure solvent (LLevap) and at least one higher vapor-pressure solvent. The dye is typically highly soluble within the solvent system.

In some embodiments, the ink formulation is an aqueous ink formulation, the solvent system being an aqueous solvent system.

In some embodiments, the ink formulation is a solvent-based ink formulation, the solvent system being an organic or solvent-based solvent system.

The aqueous solvent system contains water, which is a low (Levap) solvent. In some embodiments, the aqueous solvent system may advantageously contain, in addition, at least one of a low (Levap) and/or a very low vapor-pressure (LLevap) solvent, the additional solvent(s) forming a single phase with the water in the aqueous solvent system.

In some embodiments, the aqueous solvent system may include, in addition to the water, one or more higher vapor-pressure solvents (Mevap and/or Hevap and/or HHevap), the additional solvent(s) forming a single phase with the water in the aqueous solvent system.

In some embodiments, the aqueous solvent system may include, in addition to the water, and addition to the at least one of a low (Levap) and/or a very low vapor-pressure (LLevap) solvent, one or more higher vapor-pressure solvents (Mevap and/or Hevap and/or HHevap). As above, the higher vapor-pressure solvent(s) form a single phase with the water and with the at least one of a low (Levap) solvent and/or a very low vapor-pressure (LLevap) solvent in the aqueous solvent system.

In some embodiments, a first solvent weight ratio of Hevap, HHevap, and LLevap to the total amount of solvent Ts within the ink formulation,

$$( Hevap + HHevap + LLevap ) / Ts$$

is at least 0.6 or 0.65 or 0.7.

In some embodiments, a relative solvent weight ratio (RWSR) of LLevap to a total TH+HH of Hevap and HHevap,

$$LLevap / {T}_{H + H H}$$

is at least 0.15:1.

In some embodiments, the ink formulation is a solvent-based or organic ink formulation, in which the solvent system is an organic solvent system. The organic solvent system may advantageously contain a low (Levap) and/or very low vapor-pressure (LLevap) solvent that together form a single organic phase.

In some embodiments, the organic solvent system may further include one or more higher vapor-pressure solvents (Mevap and/or Hevap and/or HHevap), the additional higher vapor-pressure solvent(s) forming, with the Levap and LLevap solvent(s), a single phase within the organic solvent system.

As used herein in the specification and in the claims section that follows, the term “at most a high vapor-pressure (Hevap) solvent” is meant to exclude solvents that have faster rates of evaporation than Hevap, in this case, HHevap.

Similarly, the term “at most a medium vapor-pressure (Mevap) solvent” is meant to exclude solvents that have faster rates of evaporation than Mevap, in this case, HHevap and Hevap.

Similarly, the term “at least a medium vapor-pressure (Mevap) solvent” is meant to exclude solvents that have slower rates of evaporation than Mevap, in this case, LLevap and Levap.

More particularly, the volatile liquids are divided into 5 categories, as follows: LLevap<0.1 (e.g.: TPM, DPM, EB, NMP, DMSO, ethylene glycol monobutyl ether, DPM acetate).
0.1≤Levap<0.5 (e.g.: EEP, EP, PP, PMA, n-butyl proprionate, n-butanol, amyl acetate, water).
0.5≤Mevap<0.85 (e.g.: PM, isobutanol).
0.85≤Hevap<1.8 (e.g.: xylene, n-butyl acetate, isobutyl acetate, methyl isobutyl ketone, isopropanol, ethanol).
1.8≤HHevap (e.g.: toluene, methanol, n-propyl acetate, isopropyl acetate, ethyl acetate, methyl propyl ketone, methyl ethyl ketone).

The designated standard material, n-butyl acetate, is assigned a vaporization or evaporation rate of 1.0. Thus, the term “relative evaporation rate” and the like is used with reference to n-butyl acetate.

In some embodiments, the aqueous or solvent-based ink formulation may further comprise a dissolved resin (polymer).

In other embodiments, the resin (polymer) may be dispersed within the aqueous ink formulation.

In other embodiments, the resin (polymer) may be dispersed within the aqueous ink formulation so as to form an emulsion.

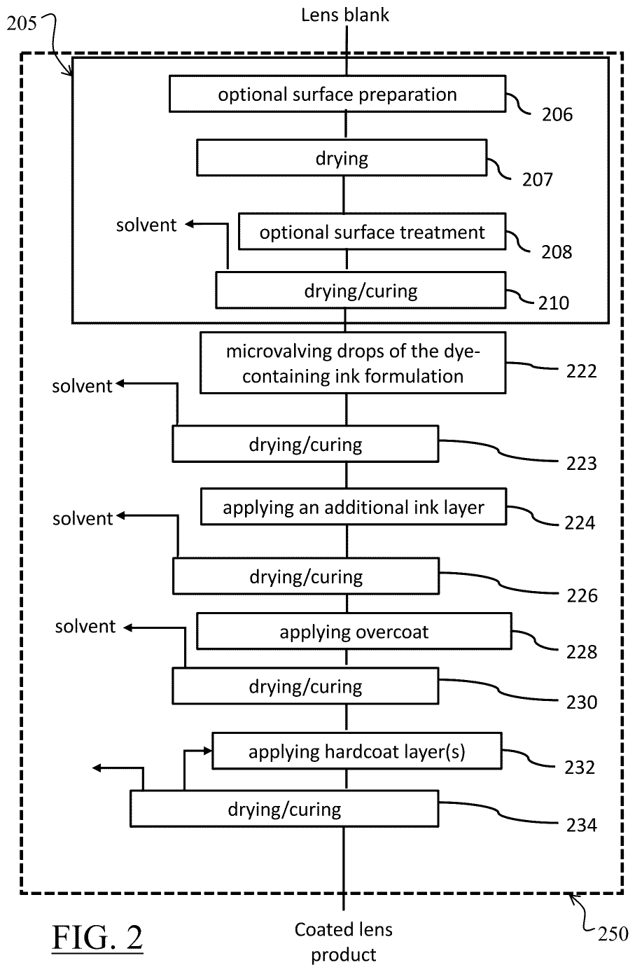

With reference now to FIG. 2, FIG. 2 provides a schematic block diagram of a process of treating an optical surface of an optical substrate (typically, a lens blank such as a curved lens blank) to produce a dried hardcoat layer, according to aspects of the present invention. The lens blank provided to the process may or may not have a protective hardcoat adhering thereto.

Before applying a wet ink layer to the optical surface of the optical substrate, the optical surface may be subjected to an optional pretreatment stage 205.

Within pretreatment stage 205, the lens blank/optical substrate may be subjected to surface preparation (optional step 206) prior to the application of the wet ink layer. Such surface preparation may include washing in water or in an aqueous cleaning solution, optionally followed by drying (optional step 207).

In some embodiments, the surface preparation of the lens surface includes an etching treatment.

In some embodiments, the etching treatment includes laser etching.

In some embodiments, the etching treatment includes chemical etching.

Before applying a photochromic ink formulation, the lens blank may be subjected to at least one surface treatment (optional step 208), e.g., an energy treatment to raise the surface energy of the optical surface.

In some embodiments, this energy treatment includes a corona treatment.

In some embodiments, this energy treatment includes a plasma treatment.

In some embodiments, this energy treatment includes an electron beam treatment.

In some embodiments, this energy treatment includes an electromagnetic (e.g., actinic) radiation treatment.

In some embodiments, this energy treatment is an electrical discharge treatment.

FIG. 3 provides optional steps for the schematic block diagram of FIG. 2, in which the surface treatment or pre-treatment (e.g., optional step 208) includes applying a liquid primer formulation to the exposed (lens) surface of the ophthalmic substrate to form a wet primer layer or coating. The wet primer layer or coating is subsequently dried or otherwise cured (e.g., at step 210), to obtain a dried primer layer or coating. Exemplary treatments include oven drying, microwave, and IR.

The drying/curing of the wet primer layer formulation may be performed by any conventional curing means for producing the cured primer layer (as described hereinabove with respect to step 104, mutatis mutandis). The curing of the wet primer layer may advantageously be performed so as to achieve a “fully-cured” primer layer.

The liquid primer formulation may be applied using various conventional technologies (each having any of various technological disadvantages), such as spin coating, slit coating, and dip coating.

In some embodiments, and most typically, the primer is microvalved onto the exposed surface of the ophthalmic substrate, as will be described in greater detail hereinbelow.

In some embodiments, the primer pre-treatment is directed to facilitate wetting of the subsequently-applied ink layer with respect to the lens surface.

In some embodiments, the primer pre-treatment is directed to facilitate adherence of this layer with respect to the lens surface.

In some embodiments, the primer is a polymeric primer.

In some embodiments, the polymeric primer is in the form of a waterborne emulsion (e.g., an acrylic emulsion).

In some embodiments, the polymeric primer is in the form of an aqueous dispersion (e.g., a polyurethane dispersion).

In some embodiments, the polymeric primer is, or includes, a UV-curable material such as UV curable oligomers, epoxy acrylates, polyester acrylates, and urethane acrylates.

In some embodiments, the polymeric primer is in the form of a solution (e.g., a polyurethane resin solution).

In some of these embodiments, the thickness and/or average thickness of the wet primer layer is at least 0.5 μm, at least 0.8 μm, at least 1 μm, at least 1.5 μm, at least 2 μm, at least 3 μm, at least 5 μm, or at least 7 μm.

In some of these embodiments, the thickness and/or average thickness of the wet primer layer is at most 80 μm, at most 60 μm, at most 40 μm, and more typically, at most 25 μm, at most m, or at most 15 μm.

In some embodiments, the method includes, following step 210, and before the microvalving of the (tint) dye formulation, effecting such an energy treatment (e.g., corona or plasma, or actinic radiation) to the top/exposed surface of the fully cured primer layer.

In some embodiments of these energy treatments, the energy treatment increases the surface energy of a target surface of the optical substrate by at least 2, 3, 5, 8, or 12 milliNewton/meter (mN/m).

In some of these embodiments, the energy treatment increases the surface energy of the target surface by at most 40, at most 30, at most 20, at most 17, or at most 14 mN/m.

With reference again to FIG. 2, following optional pretreatment stage 205, the method comprises microvalving drops of a dye-containing ink formulation (step 222), onto the optionally pre-treated lens blank/optical substrate. The dye or tint is dissolved in the liquid phase.

In some embodiments, this ink formulation may be microvalved directly onto the surface of the lens/lens blank/optical substrate.

In some embodiments, this ink formulation may be microvalved on top of a primer layer, e.g., the primer layer applied in optional surface treatment 208.

In some embodiments, the ink formulation contains contains at least one water-soluble dye or tint.

In some embodiments, the ink formulation is devoid of photochromic pigment and tint pigment.

In some embodiments, the ink formulation contains at least one polymeric resin (e.g., as a film-former and binder).

In some embodiments, the polymeric resin is present as dispersed solid particles within an ink dispersion.

In some embodiments, the polymeric resin is dissolved within the ink formulation.

In some embodiments, the ink formulation containing the dissolved polymeric resin is an aqueous ink formulation.

In some embodiments, the ink formulation containing the dissolved polymeric resin is an organic or “solvent-based” ink formulation.

A “solvent-based” ink formulation is used herein as used in the art of ink formulations. Typically, a “solvent-based” ink formulation contains at most 2% water, by weight, and more typically, is devoid or substantially devoid of water.

In some embodiments, the obtained wet ink layer obtained in step 222 may be dried or cured (step 223) to produce a dried or cured ink layer.

The drying/curing of the ink layer may be performed by any conventional curing means for producing the cured layer (as described hereinabove with respect to steps 104 and 210, mutatis mutandis). The curing of the ink layer may advantageously be performed so as to achieve a “fully-cured” primer layer.

In some embodiments, the dye containing layer, after drying and full curing, has a thickness or an average thickness within the range of 0.6 to 25 μm or 1 to 20 μm, and more typically, within a range of 1.2 to 20 μm.

More typically, the thickness or average thickness is at least 1.5 μm, at least 2 μm, at least 2.5 μm, at least 3 μm, at least 4 μm, or at least 4.5 μm.

In some embodiments, the thickness or average thickness is at most 15 μm, at most 12 μm, at most 10 μm, at most 8 μm, or at most 7 μm.

More typically, the thickness or average thickness is at most 6 μm, at most 5.5 μm, at most 5 μm, at most 4.5 μm, at most 4.0 μm, or at most 3.5 μm.

In some embodiments, an additional ink layer may optionally be applied (step 224) and dried/cured (step 226), as described hereinabove, e.g, with respect to step 104, mutatis mutandis. The additional ink formulation applied may be identical to the ink formulation applied in step 222.

In some embodiments, the additional ink formulation is a second (i.e., different) aqueous ink dispersion.

In some embodiments, the additional ink formulation is a second (i.e., different) aqueous ink solution.

In some embodiments, the additional ink formulation contains at least one dissolved dye (e.g., a tint).

In some embodiments, the additional ink formulation is a solvent-based ink formulation (e.g., containing a dissolved colorant and a dissolved polymer (resin)).

In some embodiments, the additional ink formulation contains at least one dissolved photochromic dye.

In some embodiments, the photochromic ink formulation may comprise a resin, a photochromic dye, and a solvent system.

In some embodiments, the photochromic ink formulation may comprise a softening agent for softening the resin. Typically, the softening agent forms a single liquid phase with the solvent system, the resin, and the photochromic dye.

The softening agent includes a liquid softening agent. Typically, the liquid softening agent is, includes, or consists essentially of a non-volatile liquid softening agent.

In some embodiments, the softening agent further includes a solid softening agent such as a solid polymeric softening agent.

In some embodiments, the additional ink formulation contains at least one dissolved dye (e.g., a tint).

In some embodiments, the additional ink formulation is a solvent-based formulation.

The inventors have found that various hardcoat formulations may dissolve or otherwise attack the colorant containing ink layer, and more specifically, the dye containing layer formed and cured in steps 224 and 226. However, the inventors have further discovered that by applying an overcoat layer (step 228) on top of this colorant containing ink layer and effecting drying/curing (step 230) as necessary, such attack may be inhibited or appreciably mitigated.

The tandem of steps 228 and 230 may be repeated as desired to produce additional overcoat layers.

In some embodiments, the method includes, following step 226, and before the applying of the overcoat formulation (step 228), effecting an energy treatment (e.g., any of the energy treatments described hereinabove, mutatis mutandis) to the top/exposed surface of the cured or fully-cured tinted ink layer. This may appreciably improve the adhesion between the fully-cured tinted ink layer and the overcoat layer. Typically, this step is not required for the method of the present invention.

In some embodiments, the first overcoat layer, as a wet layer, has a thickness or an average thickness within a range of 6 to 100 μm, 6 to 80 μm, 6 to 60 μm, or 6 to 50 μm.

In some of these embodiments, this layer has a thickness or an average thickness of at least 8 μm, at least 12 μm, at least 20 μm, at least 30 μm, or at least 40 μm.

In some embodiments, the first overcoat layer, as a dry layer, has a thickness or an average thickness within a range of 3 to 15 μm.

In some of these embodiments, this dry thickness or average thickness is at least 4 μm, at least 5.5 μm, or at least 6.5 μm.

In some of these embodiments, this dry thickness or average thickness is at most 13.5 μm, at most 12 μm, at most 11 μm, at most 10 μm, at most 8 μm, or at most 7 μm.

In some embodiments, the material of the dry or fully cured overcoat layer has a Konig hardness of at least 80 (seconds). More typically, this Konig hardness is within a range of 80 to 240, 80 to 210, 80 to 180, or 80 to 160.

In some embodiments, this Konig hardness is at least 90, at least 100, at least 110, at least 120, or at least 130.

In some embodiments, the first overcoat layer is or contains a thermoplastic polymer.

In some embodiments, the first overcoat layer is or contains a thermoset polymer.

In some embodiments, the first overcoat formulation is a polymer emulsion.

In some embodiments, the first overcoat formulation is a polymer dispersion.

In some embodiments, the first overcoat formulation is a polymer solution.

In some embodiments, the first overcoat formulation includes an acrylic polymer.

In some embodiments, the first overcoat formulation includes a polyurethane.

In some embodiments, the first overcoat formulation includes a polyvinyl ester resin such as polyvinyl butyral and polyvinylpyrrolidone vinyl acetate copolymer.

In some embodiments, the first overcoat formulation includes epoxy resin.

In some embodiments, the material of fully cured overcoat layer includes, predominantly includes, or consists of any of the above polymers.

In some embodiments, the PVB-based overcoat formulation may be a PVB-containing aqueous dispersion, for example, as disclosed in EP3587106 (e.g., Example 1A).

In some embodiments, the method further comprises, following the drying/curing (step 230) of the overcoat layer, applying a second or additional overcoat layer on top of the dried first overcoat layer.

In some embodiments, the method further comprises drying/curing the second or additional overcoat layer.

In some embodiments, the dried second or additional overcoat layer may exhibit increased hardness with respect to the dried first overcoat layer.

In some embodiments, the dried second or additional overcoat layer may exhibit increased a lower coefficient of linear thermal expansion (CTE) with respect to the dried first overcoat layer.

In some embodiments, the method further comprises, following curing (step 223, 226 or 228), applying a liquid (film-forming) hardcoat (“1^{st} hardcoat” or “inner hardcoat”) formulation onto the exposed optical or ophthalmic surface of the optical or ophthalmic substrate, to form a wet hardcoat layer (step 232). This may be followed by treating the wet layer to produce a dried, typically transparent hardcoat layer on the optical surface (step 234).

In some embodiments, the method includes, following step 226 or 230, and before the applying of the hardcoat formulation (step 232), effecting an energy treatment (e.g., any of the energy treatments described hereinabove, mutatis mutandis) to the top/exposed surface of the cured or fully-cured ink layer or overcoat layer, respectively. This may appreciably improve the adhesion between the fully-cured underlayer and the hardcoat layer.

In some embodiments, the applying of the (1^{st}) liquid hardcoat formulation is effected by microvalving drops of the formulation onto the exposed surface of the ophthalmic substrate.

In some embodiments, the method further comprises, following curing of the 1^{st} hardcoat layer, applying a 2^{nd} liquid (film-forming) hardcoat (“2^{nd} hardcoat” or “outer hardcoat”) formulation onto the exposed optical or ophthalmic surface of the optical or ophthalmic substrate, to form a wet 2^{nd} hardcoat layer. This optional step may be followed by treating the wet layer to produce a dried, typically transparent 2^{nd} hardcoat layer on the optical surface.

In some embodiments, the applying of the (2^{nd}) liquid hardcoat formulation is effected by microvalving drops of the formulation onto the exposed surface of the ophthalmic substrate.

In some embodiments, the hardcoat formulation base includes one or more acrylates, methacrylates, and the like, some of which are provided below in non-exhaustive fashion: hydroxyethyl acrylate, hydroxypropyl acrylate, hydroxybutyl acrylate, hydroxy-poly(alkyleneoxy)alkyl acrylate, caprolactone acrylate, ethylene glycol diacrylate, butanediol diacrylate, hexanediol diacrylate, hexamethylene diacrylate, diethylene glycol diacrylate, and triethylene glycol diacrylate.

UV catalysts for the photo-polymerization initiation may include, by way of example, any of the following materials: benzil, benzoin, benzoin methyl ether, benzoin isobutyl ether, benzophenol, acetophenone, benzophenone, as well as mixtures thereof. One skilled in the art will readily appreciate that other suitable UV catalysts may be employed.

In some embodiments, the ophthalmic hardcoat formulation is based upon Sol-gel monomers and oligomers.

In some embodiments, the hardcoat coating compositions utilized in conjunction with the present invention comprise an aqueous organic solvent mixture containing from about 10 to about 99.9 weight percent, based on the total solids of the composition, of a mixture of hydrolysis products and partial condensates of an epoxy functional silane and a tetrafunctional silane and from about 0.1 to about 30 weight percent, based on the total solids of the composition, of a crosslinking crosslinking multifunctional compound selected from the group consisting of crosslinking multifunctional carboxylic acids, crosslinking multifunctional anhydrides and combinations thereof.

Hardcoat coating compositions are well known to those skill in the art. By way of example, thermal curable coating technologies are disclosed in various patents, including the following U.S. Pat. Nos. 4,547,397, 5,385,955, and 6,538,092, and radiation curable coatings are disclosed in U.S. Pat. Nos. 4,478,876 and 5,409,965.

Referring again to FIG. 2, when two or more layers of hardcoat are applied to the substrate, the outermost layer will typically be the hardest. The one or more inner layers of hardcoat may be somewhat softer, and may be adapted such that there is a gradual change in physical properties (e.g., hardness, coefficient of thermal expansion, etc.), to impart improved mechanical properties to the layered stack. This may be of particular importance if the stack includes one or more relatively soft layers. It must be emphasized that when a single hardcoat layer is applied, this layer is the “outer hardcoat” of step 228.

In some embodiments, the outermost hardcoat layer or coating, as a wet layer, has a thickness or an average thickness within a range of 1.5 to 40 μm, 2.5 to 40 μm, 4 to 40 μm, 6 to 40 μm, 4 to 25 μm, 6 to 25 μm, 4 to 15 μm, or 6 to 15 μm.

In some embodiments, the optional at least one inner hardcoat layer or coating, as a wet layer, has a thickness or an average thickness within a range of 1 to 25 μm or within a range of 1.5 to 20 μm, and more typically, within a range of 1.5 to 15 μm, 1.5 to 10 μm, 1.5 to 7 μm, 1.5 to m, 2 to 10 μm, 2 to 7 μm, or 3 to 7 μm.

The inner coat layer or coating, after complete drying, typically has a thickness of within the range of 0.6 to 5 μm or 0.6 to 4 μm, and more typically, within a range of 0.6 to 3.5 μm, 0.6 to 3 μm, 0.6 to 2.5 μm, 0.8 to 2.2 μm, 0.8 to 2.0 μm, 0.8 to 1.8 μm, 0.8 to 1.6 μm, or 1.0 to 1.5 μm.

In some embodiments, solely a single layer of hardcoat is applied to the substrate.

In some embodiments, the hardcoat formulations include one or more type of nanoparticles, e.g., for increased hardness or strength. Such nanoparticles may include boron nitride, B4C, cubic BC2N, silicon carbide, crystalline alpha alumina (sapphire); aluminum oxide, silicon oxide, tin oxide, zirconium oxide, and titanium oxide.

Following drying/curing step 230 or drying/curing step 232, the method may include applying a liquid (film-forming) post-hardcoat formulation onto an optical or ophthalmic surface of an optical or ophthalmic substrate, to form a wet layer. This may be followed by treating the wet layer to produce a dried (fully-cured) transparent post-hardcoat layer on the optical surface.

These steps have been described hereinabove in a general fashion.

Such post hardcoat layers may include at least one of the following functionalities:
anti-wetting layer
anti-reflective layer
super hydrophobic/anti-fog layer
super hydrophilic/anti-fog layer
anti-glare layer
blue light.

It will be appreciated by those of skill in the art that these post-hardcoat formulations may be applied by microvalving or inkjetting or by conventional coating processes such as spin coating and dip coating, or PVD or CVD for the extremely thin layers.

In embodiments, a microvalve coating system comprises an ink-formulation-application station including microvalving apparatus configured to microvalve droplets of the formulation onto a target surface of an optical substrate to form a wet layer of the tinted or photochromatic ink formulation on the target surface; a drying and/or curing station configured to dry and/or cure, on the target surface, the wet layer of the ink formulation into a dry coating thereof; and optionally but typically, an optical-substrate transfer apparatus configured to transfer the optical substrate and the wet layer on the target surface thereof from the ink-formulation-application station to the drying and/or curing station.

In some embodiments, the optical-substrate transfer apparatus includes at least one of a robotic arm, a gripper, a conveyer belt, and an elevator for raising or lowering an elevation of the optical substrate and the wet layer on the target surface thereof.

In some embodiments, the microvalve coating system further comprises a controller for regulating the optical-substrate-transfer apparatus such that the transfer of the optical substrate is contingent upon a detection that the wet layer has been formed on the target surface of the optical substrate at the ink-formulation-application station.

In some embodiments, the drying and/or curing station includes at least one of a heat lamp and an oven.

In some embodiments, the drying and/or curing station includes an oven which: (i) is open when the optical substrate with the wet layer on the target surface thereof is transferred into the housing of the optical substrate with the wet layer on the target surface; and (ii) is closed, subsequent to transfer of the optical substrate to the oven, and remains closed during the drying and/curing.

In some embodiments, the system further comprises a primer application station for microvalving droplets of primer formulation onto the target surface of the optical substrate before the optical substrate is subsequently transferred to the ink formulation-application station.

In some embodiments, the microvalve apparatus of the ink-formulation-application station is configured to microvalve droplets of a tinted ink onto the target surface of an optical substrate.

In some embodiments, the microvalve coating system further comprises a surface treatment station for increasing the surface energy of the target surface of the optical substrate before microvalve-application thereon of the primer or the ink formulation.

In some embodiments, the microvalve coating system further comprises a cleaning station for subjecting the target surface of the optical substrate, before microvalve-application thereon of the primer or the ink formulation, to a cleaning process.

In some embodiments, the surface treatment station includes at least one of corona-treatment-apparatus and plasma-treatment apparatus.

In some embodiments, the hardcoating-formulation-application station includes a reservoir of the hardcoating formulation and is configured to microvalve, onto the target surface of the optical substrate, the hardcoating formulation stored in the reservoir.

In some embodiments, the system is devoid of any dip coating apparatus.

In some embodiments, the system is devoid of any spin coating apparatus.

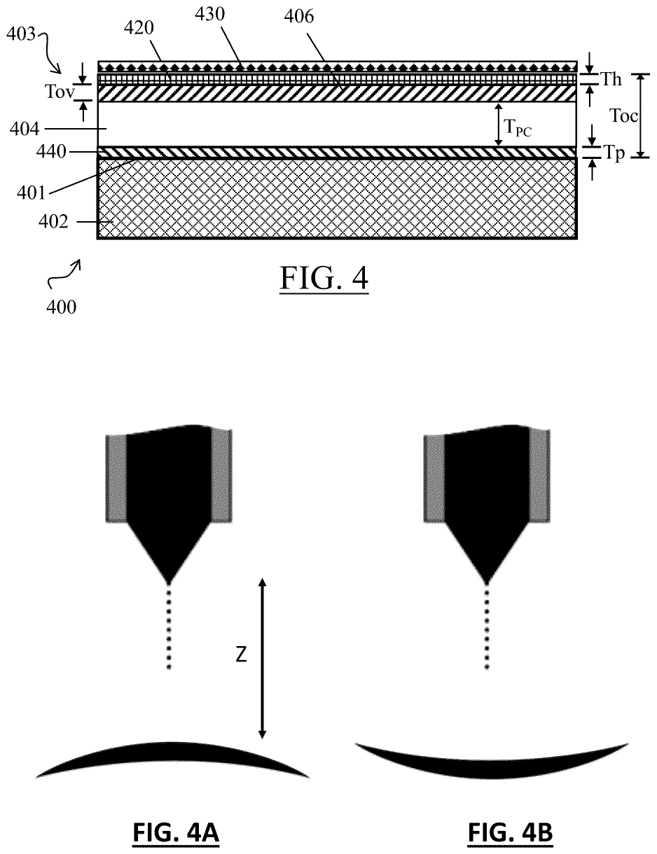

FIG. 4 is a schematic cross-sectional view of a multi-layered optical or ophthalmic device, component or structure 400, which includes an optical or ophthalmic substrate 402 having an optical or ophthalmic construction 403 fixedly attached to a broad surface 401 of the optical or ophthalmic substrate 402. Construction 403 further includes an optional primer layer 440 disposed between broad surface 401 and ink layer 404. The thickness of ink layer 404 (which in some embodiments contains aqueous dye or tint, and in other embodiments contains photochromic dye) is designated as T_{PC}, while the thickness of primer layer 440 is designated as Tp. Above ink layer 404 may be disposed one or more additional ink layers (not shown) photochromic ink layer, an overcoat layer 406, substantially as described hereinabove. The thickness of overcoat layer 406 is designated as Tov. Above overcoat layer 406 may be disposed one or more hardcoat layers 420, according to further features of the present invention. Above hardcoat layer(s) 420, whose thickness is designated as Th, one or more post-hardcoat layers 430 may be disposed. The entire thickness of optical construction 403 is designated as Toc.

In some embodiments, Tp is within a range of 0.2 to 3 μm.

In some embodiments, Tp is at least 0.4, at least 0.6 or at least 0.8 μm.

In some embodiments, Tp is at most 2.5 μm, at most 2 μm, at most 1.6 μm, at most 1.3 μm, or at most 1.0 μm.

In some embodiments, Trc is within a range of 1 to 10 μm.

In some embodiments, Trc is within a range of 1.2 to 8 μm.

In some embodiments, Trc is at least 1.5, at least 1.8, at least 2.0, at least 2.5, or at least 3 μm.

In some embodiments, Trc is at most 7 μm, at most 6 μm, at most 5 μm, at most 4.5 μm, or at most 4 μm.

In some embodiments, Tov is at least 4, at least 6, at least 7, or at least 7.5 μm.

In some embodiments, Tov is at most 18 μm, at most 15 μm, at most 13 μm, at most 12 μm, or at most 11 μm.

In some embodiments, the fully-cured hardcoat layer has at least one of a local thickness Th-1 and an average thickness Th-a of at least 1.2 μm, at least 1.5 μm, at least 1.8 μm, at least 2 μm, at least 2.5 μm, and more typically, at least 3 μm or at least 3.5 μm.

In some embodiments, at least one of Th-1 and Th-a is at most 8 μm, at most 6 μm, or at most 4.5 μm, at most 3.5 μm,

When applied directly on the overcoat layer, the fully-cured hardcoat may have a thickness or an average thickness within a range of 1.2 to 3.5 μm, 1.5 to 3.5 μm, or 1.8 to 3 μm. More typically, the thickness or average thickness is at most 2.7 μm, at most 2.4 μm, at most 2.2 μm, or at most 2 μm.

In some embodiments, at least one of Th-1 and Th-a is at most 8 μm, at most 6 μm, at most 4.5 μm, at most 3.5 μm, at most 3 μm, at most 2.7 μm, at most 2.4 μm, or at most 2.2 μm.

With regard to the entire thickness Toc of optical construction 403, in some embodiments, the dry (cured) optical construction has an average thickness within the range of 1 to 50 μm, 3 to 50 μm, or 4 to 50 μm.

In some embodiments, Toc is at least 5 μm, at least 7 μm, at least 8 μm, at least 10 μm, or at least 12 μm.

In some embodiments, Toc is at most 40 μm, at most 30 μm, at most 25 μm, at most 20 μm, at most 15 μm, or at most 12 μm.

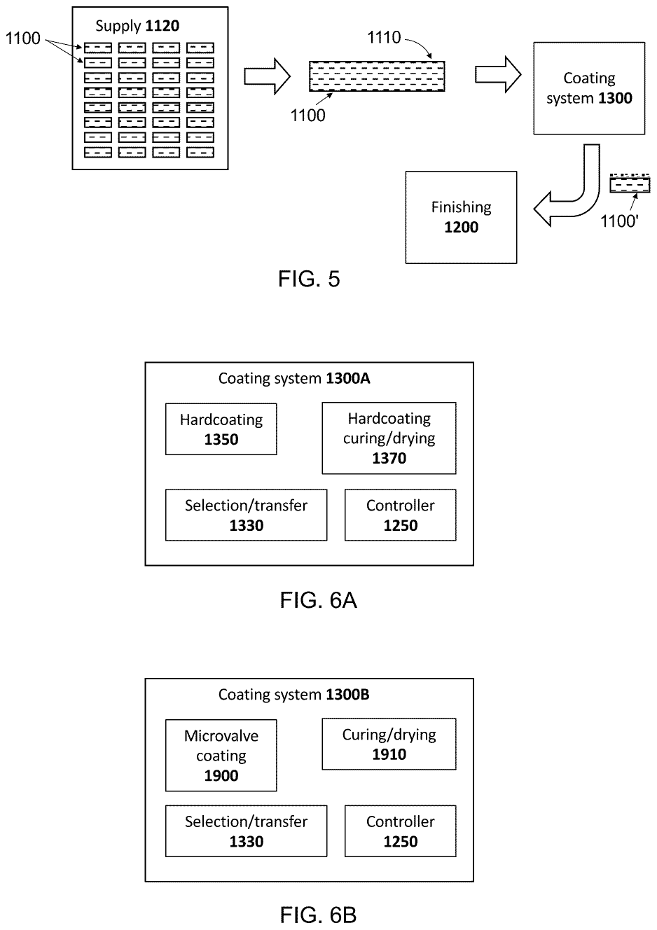

FIG. 5 schematically illustrates selected steps of a process for coating an optical or ophthalmic substrate (OS) 1100, for example a lens blank, using a coating system 1300.

Examples of OS 1100 (e.g. to apply thereon one or more coating using any teaching or combination of teachings disclosed herein) include but are not limited to: (i) eyeglass lenses; (ii) Single-Vision Lenses; (iii) Multifocal Lenses; (iv) Anti-fatigue lenses (e.g. including a single-vision prescription and a boost of magnification at the bottom of the lens); (v) Progressive lenses (e.g. designed to correct for multiple viewing distances—including far, intermediate and near—in one lens); (vi) Prism Lenses; (vii) Spherical lenses; (viii) Cylindrical lenses. Other examples of OS 1110 include lenses of a virtual-reality (VR) device including but not limited to VR glasses or VR goggles.

Element 1110 schematically represents a target surface of an optical substrate 1100 to be coated with at least one dried layer, e.g. multiple dried layers stacked directly or indirectly on each other. For example, an optical substrate (OS) 1110 may correspond to optical or ophthalmic device, component or structure 400 (e.g. an uncoated version or partially uncoated version thereof). For example, the target surface 1110 may correspond to surface 401, or to any other surface of any other layer of FIG. 4.

For example, the target surface 1110 may correspond to the ‘outward-facing surface’, i.e. that which will face away from the wearer of the glasses of an eyeglass lens.

Target surface 1110, before being modified by coating system 1300, may be uncoated or may be pre-coated, e.g. before ‘delivery’. In contrast, coated substrate OS 1100′ has a coated version of target surface 1110—i.e. after a coating is applied by coating system 1300.

In embodiments, an optical coating system 1300 may be employed to provide ‘customization’ of optical articles-of-manufacturing (e.g. eyeglasses). For example, optical coating system 1300 may be deployed in a factory or in a store-front, e.g., of an optometrist. For example, optical coating system 1300 may include, or may be in communication with, a digital computer (not shown), which stores and/or includes directives for producing a customized optical article-of-manufacturing.

In one non-limiting use-case, a customer having a certain optical prescription may require one or more of, e.g. any combination of: (i) specific tint or target color—i.e. to customize her/lens to a specific color; and/or (ii) a specific physical or characteristic such as, e.g. abrasion resistance; and/or (iii) a presence or absence of photochromatic features; and/or (iv) a desired glossiness; and/or (v) a desired presence or absence of varnish.

The manufacturing of the lens geometries, e.g. to satisfy a certain optical prescription and/or shape, may optionally be carried out ‘off site’ in a different location from where the coating system 1300 is deployed.

Since the possible combinations of articles-of-manufacturing could be very large such as many types of lens geometries, multiple types of ‘color features’ for coating a lens, or target colors to coat the lens, target digital pixel-patterns of lenses, etc., it may not be practical to maintain an inventory of ‘every possibility.’

Instead, it may be desirable to maintain a supply 1120 of multiple types of ‘raw material’ substrates 1100 based on lens geometry. Thus, a specific workpiece such as OS 1100 may be selected from a plurality of candidates, which can optionally be stored in a digital computer, according to specified geometric properties such as, for example g. properties expressed as an optical prescription. An ‘input’ OS 1100 may be selected by rejecting some candidate in favor of a ‘preferred candidate’ OS 1100 whose geometric properties best match required lens-geometry and/or refractive index and/or multi-focal directive and/or astigmatism directive and/or optical prescription data.

The coated OS 1100′, such as an eyeglass blank or an eyeglass lens can be cut and/or installed into eyeglass frames in a lens-cutting and/or glasses-frame installing apparatus 1200.

OS 1100, in some embodiments, is rigid—e.g. having an average thickness (alternatively or additionally, a thickness in at least one location of OS 1100) that is at least 0.5 mm or at least 1 mm or at least 2 mm or at least 3 mm).

As will be discussed below, a coating system 1300 in various embodiments apply one or more dried layers of optionally transparent material dried layer of material or multiple dried layers onto or over surface 1110 of OS 1100.

The combination of: (A) operating parameter(s) of coating system 1300 and/or (B) physical and/or chemical properties of materials (e.g. viscosity and/or fraction of solids and/or surface-energy, employed by any implementation or embodiment of coating system 1300 may be such that the layers, i.e. dried and/or transparent layers produced on or over surface 1110 of OS 1100, have one or more specific properties.

Such properties include, but are not limited to, (i) thickness of a particular dried transparent layer or ratios between different transparent layer ratios (ii) area over which the transparent layer or a convex subportion thereof is continuous over the entirety of the area of convex subportion thereof, (iii) color and/or optical density of any dried layer; (iv) mechanical properties of any dried layer or combination of layer(s). Thus, system 1300 may be configured to manufacture on surface 1110 of OS 1100 to obtain any property or combination of properties of wet or dried layers disclosed herein.

As will be discussed below, operating parameters of coating system 1300 or any one or more of its components, including components controllable, e.g., by controller 1250 (not shown in FIG. 5) can include, without limitation: (i) parameters for microvalving or inkjetting drops (or, equivalently as used herein: droplets) such as, for example, drop velocity, drop-deposition frequency, drop size and/or volume, spacing between droplets, or any other operating parameter for depositing drop or droplets, drop or droplet ejection-speed, and gap-distance between a nozzle of a microvalve or inkjet device and target surface 1110; (ii) drying time or drying temperature or drying intensity or power or any other parameter related to drying of a wet layer such as, for example, oven temperature, parameters of convective and/or radiative drying such as, for example, UV intensity; (iii) relative motion between any nozzle for delivering drops or droplets and target surface 1110; (iv) properties related to treating surface 1110 of OS 1100, e.g. to obtain a desired surface-energy or an energy in a certain range; (v) selection of a formulation, or a container, cartridge or reservoir of the formulation, from a plurality of candidates and/or mixing of a formulation; and ventilation operating parameters.

In different embodiments, the term ‘apparatus’ may refer to a specific station (e.g. drying station and/or wet layer-application station for any wet layer). Thus, any reference to ‘apparatus’ may also be taken as (i.e. in embodiments of the invention) a ‘station’.

In various embodiments, the components of optical coating system 1300 are configured and/or arranged to perform any method described here in (e.g. reference to FIGS. 1-3—all steps or any combination of step(s) to provide any feature of combination of feature(s)—not all steps are required.

The resulting coated OS 1100′ may include any dry layer or combination of layers or feature(s) thereof or combination(s) thereof taught with reference to FIG. 4 (not all layers are required)—the layers produced and properties thereof (e.g. within the framework of FIG. 4) are according to the specific elements (and their operating parameter(s) and formulation(s)) of a specific implementation of coating system 1300—we note various versions of system 1300 are described herein.

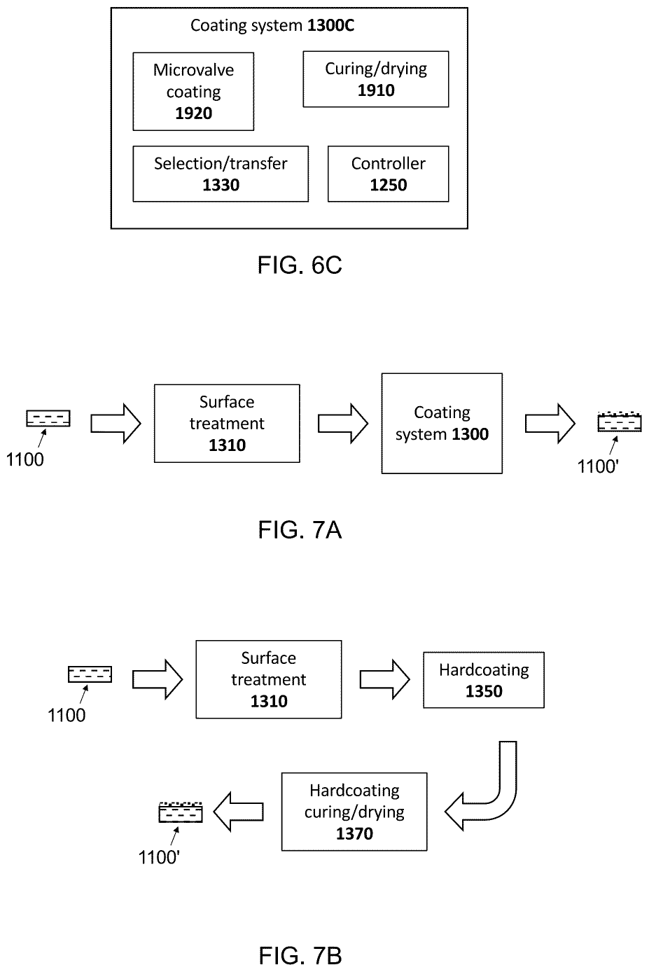

Various examples and/or embodiments of coating systems 1300 and/or processes related to coating systems are schematically presented in FIGS. 6A-6C, 7A-7B, 8, 9, 10A-10C, and 11 as block diagrams and/or flow-diagrams illustrating various systems and methods according to various embodiments of the disclosure.

FIG. 6A shows a block diagram of an exemplary coating system 1300A. The coating system 1300A can include any one or more (or all) of (i) a hardcoating-formulation application apparatus 1350 for applying a coating or layer of a hardcoating formulation e.g. by microvalving, (ii) hardcoat-drying and/curing apparatus 1370 for drying and/or curing a wet layer of a hardcoat formulation, (iii) selection and/or transfer apparatus 1330, and a (IV) controller 1250. In some embodiments, the hardcoat formulation comprises an ink, e.g., for tinting and/or photochromic tinting, and/or an electrochromic ink. The wet layer can be ‘thin’, characterized by having a thickness of at most 100 or 90 or 75 or 50 or 25 or 20 or 15 or 10 microns.

FIG. 6B shows a block diagram of another exemplary coating system 1300B. The coating system 1300B can include any one or more (or all) of (i) a microvalve-based coating apparatus 1900 for coating a surface of an optical substrate 1100, configured, for example, to coat on the surface 1110 of optical substrate 1100 by microvalving liquid drops to form one or more thin layers of a formulation. Such a thin layer can be characterized by having a thickness of at most 100 or 90 or 75 or 50 or 25 or 20 or 15 or 10 microns. (ii) drying and/or curing apparatus 1910, (iii) selection and/or transfer apparatus 1330, and (iv) a controller 1250. In an example, one or more wet layers applied by microvalve-based coating apparatus 1900 are subjected to a drying and/or curing process by drying and/or curing apparatus 1910. Examples of the ‘formulations’ which can be applied by microvalve-based coating apparatus 1900 are: (i) hard-coating formulations which may be microvalved to produce a layer of the hard-coating formulation, (ii) ink-formulations, e.g., for tinting or photochromic and/or electrochromic ink to produce a layer of the ink formulation; (iii) surface-energy-increasing formulations which may be microvalved to produce a layer of the surface-energy-increasing formulation so as to increase the surface energy of the target surface 1110 of the optical substrate 1100.

In embodiments related to FIG. 6B, one of more of the features can be provided by the coating system 1300B (or elements thereof): (i) microvalve-based coating apparatus 1900, forms by microvalving drops onto target surface 1110, one or more continuous wet layers, which may be stacked by drying a preceding layer; (ii) microvalve-based coating apparatus 1900 for forming, by microvalving drops onto the target surface 1110, a continuous wet layer that is thin—characterized by having a thickness of at most 100 or 90 or 75 or 50 or 25 or 20 or 15 or 10 microns; and (iii) drying and/curing apparatus 1910 which transforms continuous wet layer into a continuous dry layer for one layer or for multiple stacked layers.

The skilled artisan will appreciate that microvalve-based coating apparatus 1900 may deliver only one such layer or may deliver a plurality of such layers such that layers are stacked on each other. For example, it can be that a first layer may first be dried by the drying and/or curing apparatus 1910 before a second layer is applied directly or indirectly over the first layer.

The exemplary coating system 1300C of FIG. 6C is a specific example of coating system 1300B of FIG. 6B where multiple layers are stacked on each other on upper target surface 1110 of optical substrate 1100. At least one of such layers is produced by microvalving drops—e.g. by microvalve based coating apparatus 1900 or 1920.

Reference is now made to FIG. 7A. In the example of FIG. 7A, an optical substrate 1100 is first treated by surface-energy-increasing apparatus 1310 to increase the surface energy of the target surface 1110 before coated by the coating system 1300A or any other coating system 1300 disclosed herein to apply one or more layers, e.g., with a hardcoating formulation.

FIG. 7B is another example of a coding system where optical substrate 1100 is first treated by surface-energy-increasing apparatus, and subsequently coated by hardcoating-formulation application apparatus 1350 to apply a wet layer and/or coating of a hardcoating formulation. This wet layer and/or coating of a hardcoating formulation is subsequently dried and/or cured by hardcoat-drying and/or curing apparatus 1370, to yield coated optical substrate 1100′. The system of FIG. 7B may also including (i) selection and/or transfer apparatus 1330 and/or (ii) a controller 1250.

According to embodiments, a coating system 1300 may include any one or more of the following components:

One or more controllers 1250: for simplicity, only a single controller 1250 is shown in the various drawings. A controller 1250 can regulate operating parameters of any other element of a coating system 1300, including, but not exhaustively: microvalving apparatus, drying apparatus, ink-jet apparatus, transfer apparatus, or any other apparatus or combination if present. The controller 1250 may be part of and/or be located in the coating system 1300 or in any of the components, and/or may be located separately and/or remotely. Controller 1250 may include any electrical and/or electronic components required to perform its function of controlling any component or combination of components.

In some embodiments of the invention, any coating system 1300 disclosed herein may include data-acquisition and/or monitoring apparatus 1430 such as, for example, imaging and/or inspection components. A controller 1250 may directly or indirectly receive data from such data-acquisition and/or monitoring apparatus 1430.

Hardcoating-formulation application apparatus 1350 microvalves drops of hardcoat formulation onto the target surface 1110 of an OS 1100 in order to produce on the surface 1110 a wet layer of hard coat formulation from the microvalved droplets of hardcoat formulation. The hardcoating apparatus 1350 can be in communication with and/or loaded with a hardcoating formulation. In any of the embodiments of the coating system, a formulation, including without limitation a hardcoating formulation, can be disposed within a cartridge or any other container or reservoir.

The hardcoating formulation employed by the hardcoating apparatus 1350 may be in accordance with any hardcoat formulation teaching disclosed herein or any combinations of the teachings. As already disclosed hereinabove, the hardcoating formulation employed by a microvalve-based apparatus, e.g., microvalving apparatus 1900, can optionally also be an ink.

In various embodiments, hardcoating apparatus 1350 may be configured and/or regulated by the controller 1250 to produce a wet layer of hardcoat formulation having specific properties. For example, the wet layer can comprise a sub-100p wet layer of hardcoat formulation. For example, the wet layer can have a thickness of at most 90 microns or at most 75 microns or at most 50 microns or at most 25 microns or at most 20 microns or at most 15 microns or at most 10 microns. For example, the wet layer may be continuous at least over a certain area (e.g. at least over a convex region having a specific area—e.g. at least 1 cm\hat{ }2 or at least 2 cm\hat{ }2 or at least 4 cm\hat{ }2 or at least 8 cm\hat{ }2).

In various embodiments, apparatus 1350 is configured, e.g., by controller 1250 and/or by formulation properties to perform step 102 of FIG. 1 and/or step 224 of FIG. 2.

Hardcoat-drying and/or curing apparatus 1370 can be provided and configured for applying thermal energy to a wet layer of hardcoat formulation such as that produced by hardcoating apparatus 1350 and having a thickness or any other properties taught herein, to convert this wet layer in hardcoat formulation into a dried hardcoat layer having any property disclosed herein. In various embodiments, the hardcoating apparatus 1350 is configured, e.g., by the controller 1250 and/or by formulation properties to perform step 102 of FIG. 1 and/or step 224 of FIG. 2.

Selection and/or transfer apparatus 1330 for selecting and/or providing relative motion of OS 1110 relative to any apparatus and/or unit and/or station of 1300 or component thereof. This ‘relative motion’ may transport, e.g., by translation and/or rotational motion, the OS 1100 or portion thereof and/or any apparatus and/or component and/or station of the coating system 1300 relative to the OS 1100.

In different embodiments, selection and/or transfer apparatus 1330 may be controlled at least in part by the controller 1250, e.g. to achieve a directive stored in a digital computer, such as, for example a target property of hardcoating layer.

In various embodiments, selection and/or transfer apparatus 1330 may include one or more of: a robotic arm, a gripper, a conveyer belt, and an elevator for raising or lowering an elevation of the optical substrate and the wet layer on the target surface thereof.

Selection and/or transfer apparatus 1330 may be configured for such relative motion between components of coating system 1300 and/or for selecting an OS 1110 from a plurality of candidates according to a directive in computer storage and/or read by a digital computer such as, for example, an optical prescription.

Microvalve-based coating apparatus 1900 or 1920: any wet layer disclosed herein may be applied by microvalving apparatus 1900, which in embodiments can be controlled by the controllers 1250, as in, for example, step 102 of FIG. 1. The operating parameters of 1900 may depend on the specific layer to be formed or the formulation from which this layer is produced. Thus, apparatus 1900 may, in different embodiments, perform step 224 of FIGS. 2 and/or 228 of FIGS. 2 and/or 310 of FIG. 2A and/or 324 of FIG. 3 and/or step 228 of FIG. 3.

A coating system may include a single instance of microvalving apparatus 1900 or 1920 configured to operate in accordance with multiple sets of operating parameters depending on the wet layer to be dried/converted into a dry layer.

Any dried layer disclosed or claimed herein, for example a dried layer produced by any method or system disclosed herein, e.g., by step 104 of FIG. 1 or step 210/310 of FIG. 2/3 or step 226/326 of FIG. 2/3 or step 230/330 of FIG. 2/3 or step 234/334 of FIG. 2/4 and/or produced by element 1370 or 1910 or 1420 or 1530 or element 1630 or element 1650 or element 1670) may be considered continuous and/or thin as the terms are defined herein.

A ‘continuous’ dried layer is one that is continuous over an entirety of a virtual convex-region as schematically illustrated, for example, in FIG. 12D, where region 1962, region 1966, and region 1968 are examples of convex regions while region 1964 is a counter—example. In examples, the area of a convex-region of target surface 1110 may be, in different embodiments, at least 0.5 cm² or at least 1 cm² or at least 2 cm² or at least 4 cm² or at least 8 cm² or at least 10 cm² or at least 20 cm²).

The boundaries of the region are ‘virtual’ rather than any physical boundaries—thus, the term ‘convex region’ refers to the shape of these ‘virtual’ boundaries rather than to any geometric property of the physical topography of target surface 1110 of optical substrate 1100.

Thus, as shown in FIGS. 12B and 12C, even when topographically surface 1100 is completely concave as in FIG. 12C, it is possible to define thereupon, by defined/virtual boundaries, a convex-portion or convex-region within the topographically-concave surface 1100.

A thickness of a ‘thin’ dried layer is at most 20 microns or at most 15 microns or at most 10 microns or 5 microns or at most 3 microns or at most 1 micron.

In any embodiment disclosed herein, any ‘dried layer’ formed from a ‘wet layer formed by microvalved-drops’ is sourced at least 75% wt/wt or at least 80% wt/wt or at least 90% wt/wt from the microvalved droplets.

In any embodiment disclosed herein, any ‘dried layer’ produced from a ‘wet layer formed by drops primarily in the [r mm, s mm](r and s are both positive numbers, mm is millimeters) range’ is a dried layer that is sourced at least 75% wt/wt or at least 80% wt/wt or at least 90% wt/wt from drops (i.e. to produce the precursor wet layer which is then dried) whose width is both at least r mm and at most s mm. In different embodiments, any dried layer disclosed herein is formed primarily from drops in the [0.1 mm, 3 mm] range.

In various embodiments, any dried layer disclosed herein is formed primarily from drops in the [0.1 mm, 2 mm] range. In different embodiments, any dried layer disclosed herein is formed primarily from drops in the [0.1 mm, 1.5 mm] range. In different embodiments, any dried layer disclosed herein is formed primarily from drops in the [0.1 mm, 1 mm] range. In different embodiments, any dried layer disclosed herein is formed primarily from drops in the [0.01 mm, 1 mm] range. In different embodiments, any dried layer disclosed herein is formed primarily from drops in the [0.15 mm, 3 mm] range. In different embodiments, any dried layer disclosed herein is formed primarily from drops in the [0.2 mm, 1 mm] range.

Alternatively or additionally, multiple instances of 1900 or 1920 may be provided, each for drying a different wet layer of formulation and each operating according to different operating parameters.

(A) A drying and/or curing apparatus 1910 can include, in different implementations, an oven and/or UV apparatus or other element for converting a wet layer of formulation into a dried layer, including, optionally, a transparent layer. The operating parameters of the drying and/or curing apparatus 1910 depend upon the specific formulation and its properties. For example, for a hardcoating formulation, a drying temperature and/or energy and/or duration required/employed may exceed that required/employed for a ‘primer formulation.’ Any coating system 1300 may include a single 1910 or multiple drying and/or curing apparatus 1910 and the operating parameter(s) thereof depend on the formulation and/or structure of the specific wet layer to be converted into a dry layer.

In various embodiments, a drying and/or curing apparatus 1910 can be configured to perform step 104 of FIG. 1 and/or step 207 or FIG. 2 and/or step 210 of FIG. 2 and/or step 226 of FIG. 2 and/or step 230 of FIG. 2 and/or step 234 of FIG. 2 and/or step 320 of FIG. 2A and/or step 307 of FIG. 3 and/or step 310 of FIG. 3 and/or step 326 of FIG. 3 and/or step 330 of FIG. 3 and/or step 334 of FIG. 3.

(B) A surface-energy-increasing apparatus 1310, as shown in further detail in FIG. 9, can be provided for increasing a surface energy of a target surface 1110 of the optical substrate 1100. In various embodiments, surface-energy-increasing apparatus 1310 operates to increase the surface energy of target surface 1110 of OS 1100 by at least 2 mN/m, or at least 3 mN/m, or at least 5 mN/m, or at least 8 mN/m, or at least 12 mN/m. Alternative or additionally, the surface-energy-increasing apparatus 1310 operates to increase the surface energy of target surface 1110 of OS 1100 by at most 40 mN/m, or at most 30 mN/m, or at most 20 mN/m, or at most 17 mN/m, or at most 14 mN/m. FIG. 7C-7E illustrate non-limiting examples of coating systems 1300 that include surface-energy-increasing apparatus 1310. In different examples, as shown in the block diagram of FIG. 9, surface-energy-increasing apparatus 1310 includes plasma-treatment apparatus 1501A and/or corona-treatment apparatus 1510B and/or electron-bean apparatus 1510C and/or electron-discharge apparatus 1510D. Alternatively or additionally, apparatus 1310 includes (i) a drop- and/or droplet-deposition device 1520 (e.g. microvalve or inkjet loaded or in fluid communication with appropriate surface-energy-increasing formulation according to any of the teachings herein and (ii) a drying and/or curing apparatus 1530 operating at lower power and/or lower temperature and/or lower duration than that for drying the wet hardcoating layer, e.g., because of the wet layer of the surface-energy-increasing formulation. In various embodiments, apparatus 1310 is configured to perform step 208 of FIGS. 2 and/or 308 of FIG. 3. Alternatively or additionally, apparatus 1520 (i.e. any instance thereof—if present) is configured to perform step 310 of FIG. 2A.

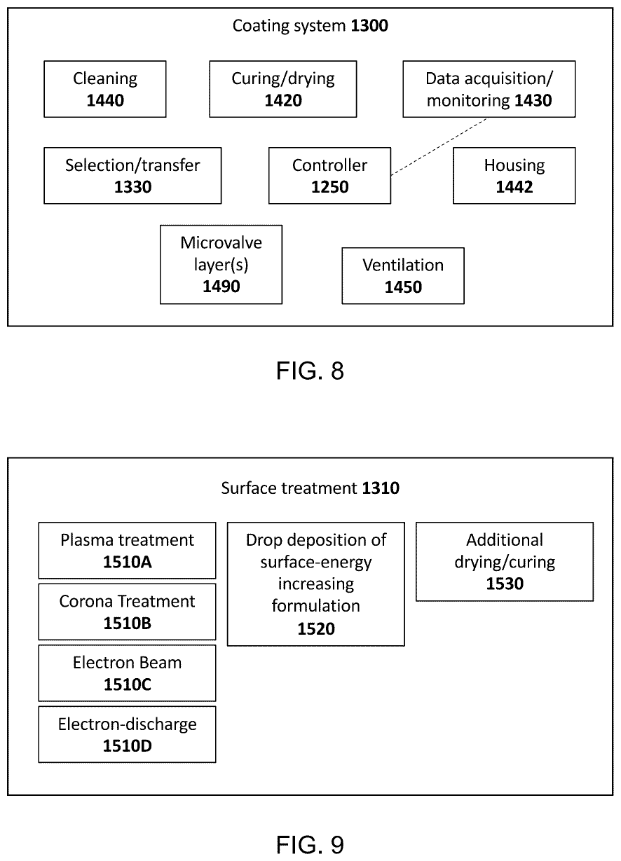

(C) With respect to the microvalve application apparatus 1490 and additional drying and/or curing apparatus 1420 of FIG. 8, there may be more than one microvalve based layer-application apparatus. Similarly, there may be more than one drying apparatus as discussed elsewhere.

Still referring to FIG. 8, any coating system 1300 disclosed herein may include any of the following in any combination:
(i) Cleaning apparatus 1440 can be provided to treat the target surface 1110 of the optical substrate 1100, e.g., for surface-cleaning. For example, the cleaning apparatus 1440 can be configured to apply a washing solution and/or soap and/or a surfactant to the target surface 1110 of the optical substrate 1100. For example, the cleaning apparatus 1440 can be configured to dry an applied cleaning fluid and/or to subject the target surface 1110 to a dust-removal process. For example, the cleaning apparatus 1440 can treat the target surface 1110 before the target surface 1110 is subsequently subjected to a surface-energy-increasing process (e.g. by the apparatus 1310 or before the target surface 1110 is targeted for coating by any of the coating apparatuses disclosed herein.
(ii) Additional drying and/or curing apparatus(es) 1420—for example, in addition to 1370 or 1910. For example, multiple wet coatings may be applied to target surface 1110 of optical substrate 1100. For example, a first wet coating or coating-layer may be dried and/or curried by a first drying and/or curing apparatus (e.g. 1370 or 1910) and a second wet coating or coating-layer may be dried by element 1420.
(iii) Ventilation apparatus 1450;
(iv) Housing 1442;
(v) Microvalve-based additional-layer Application Apparatus(es) 1490—as noted above, there may be more than one microvalve based layer-application; and
(vi) Selection and/or transfer apparatus 1330 (e.g. for substrate and/or solvent and/or cartridge and/or other apparatus).

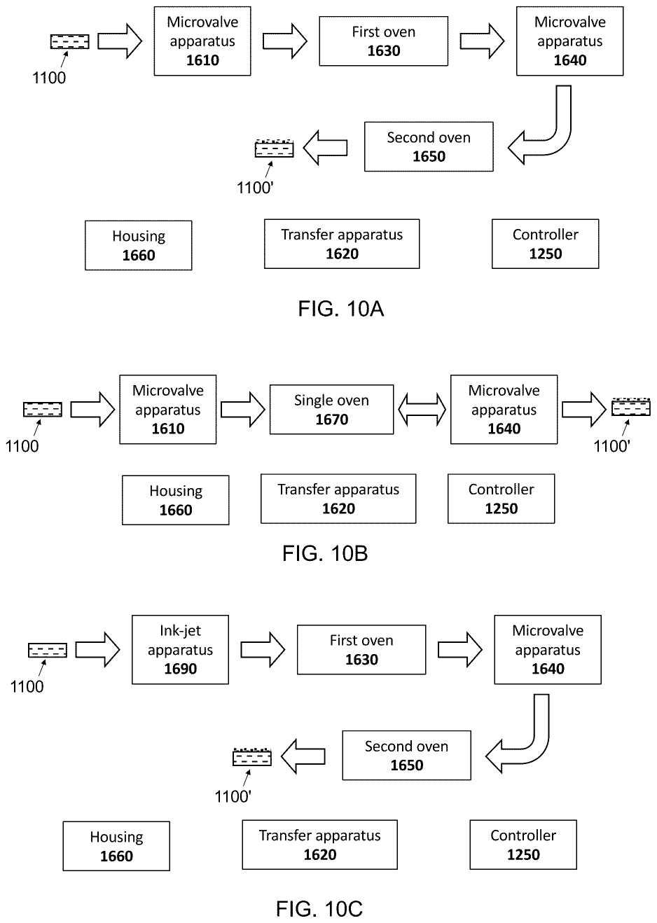

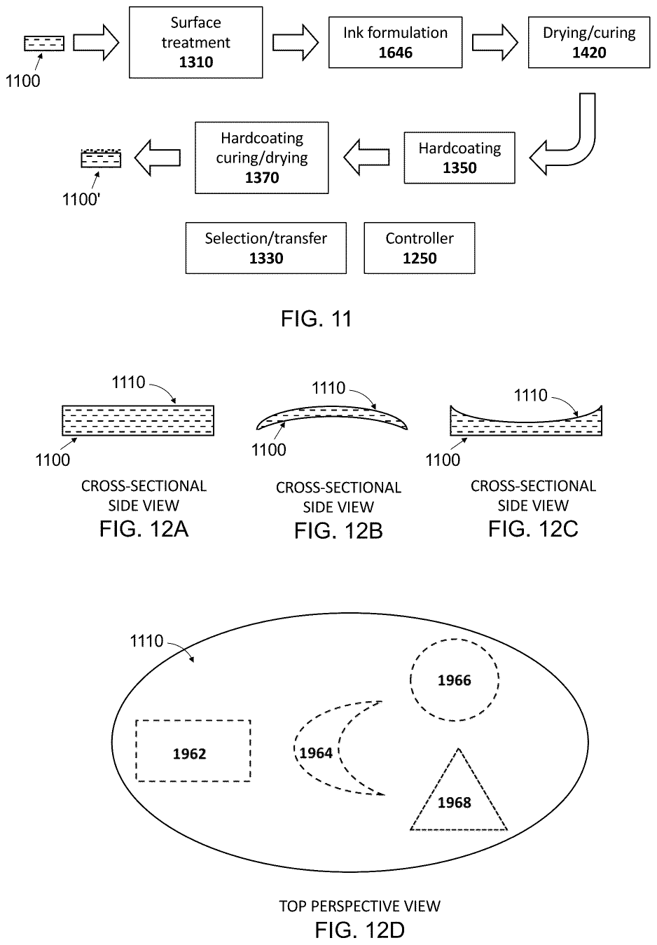

FIGS. 10A-10C and 11 schematically illustrate non-limiting examples of operating respective exemplary coating systems 1300 comprising one or more ovens for drying and/or curing a wet coating on an optical substrate 1100.

FIG. 10A illustrates an exemplary operating process as follows:
(i) A first microvalve apparatus 1610 in communication with and/or loaded with surface-energy-increasing formulation is provided for increasing the surface energy of target surface 1110 of an optical substrate 1100 so that drops that are microvalved to the surface 1110 collectively form a wet coating of the surface-energy-increasing formulation on the target surface 1110;
(ii) A first oven 1630 is provided, to operate a drying process at a ‘low’ temperature and/or short duration—i.e. for a drying process of relative ‘low’ duration) in order. to dry the wet coating delivered by microvalve apparatus 1610;
(iii) A second microvalve apparatus 1640 is provided for applying a second wet coating by microvalving drops of a second formulation—for example, a hardcoating—onto the target surface 1110 after the wet coating of the surface-energy-increasing formulation is dried by the first oven 1630; and
(iv) a second oven 1650 is provided for drying and/or curing the wet coating of the wet coating of the second formulation.

The example of FIG. 10B shows a setup comprising a single oven 1670 rather than multiple ovens. A first transfer of the optical substrate 1100 is made into the single oven 1670 for drying/curing the wet coating from the microvalve apparatus 1610. A first transfer is made out of the single oven 1670 after the first drying/curing process. A second transfer is made into the single oven 1670 to dry or cure the wet coating from second microvalve apparatus 1640. The requisite movement of substrate 1100 may be performed at least in part by the optical-substrate transfer apparatus 1602 and at least some of the movements can be made automatically or robotically.

FIG. 10C shows a third setup in which the coating is performed by an ink-jet apparatus 1690 instead of a microvalve apparatus. The setup and process are otherwise the same as that shown in FIG. 10A.

FIG. 11 shows a fourth setup similar to that of FIG. 7B with the addition of an ink-formulation apparatus 1646 and an ink-layer drying and/or curing apparatus(s) 1420.

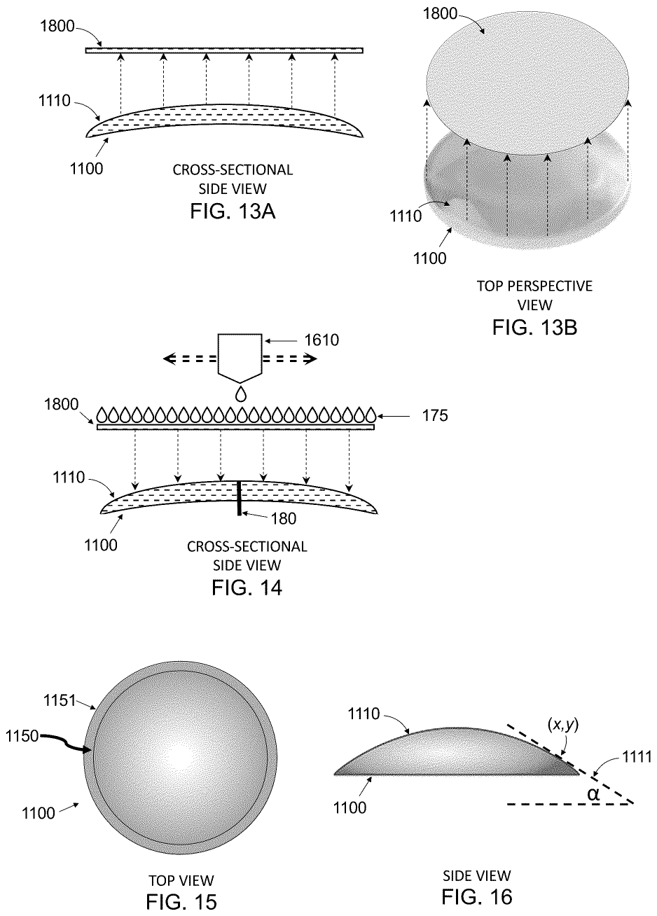

With reference now to FIGS. 13A, 13B, 14, 15 and 16, FIG. 13A shows a cross-sectional side view, and FIG. 13B shows a top perspective view, of a virtual two-dimensional projection 1800 of a curved surface 1110 of an exemplary optical substrate 1100. In embodiments, a coating system, such as any one of the coating systems 1300 disclosed herein comprising a controller 1250, can be configured to microvalve drops with a constant density in terms of volume of formulation per unit of area of the two-dimensional projection 1800. The term ‘constant density’ as used herein can mean exactly constant, or alternatively can mean within +10%, or within +5%, or within ±2%, or within ±1% of a mean value of the ‘density’, i.e., the volume of formulation per unit of area of the two-dimensional projection, ratio for the entirety of two-dimensional projection. The constant density or, in the alternative, the density within one of the given ranges from the mean, can be measured in a small area of the two-dimensional projection such as, for example, any subdivision of the two-dimensional projection 1800 having an area of 5% or more of an area of the projection 1800.

The applied formulation can include any one or more of the inks and/or coating formulations disclosed herein. In some embodiments, the formulation is selected, inter alia, for physical characteristics that make the formulation suitable for being deposited on curved surfaces in the manner described here.

The term ‘configured’ in the foregoing should be understood as including ‘programmed’ and/or ‘programmable’, i.e., that the controller 1250 is so programmed or programmable to control the microvalving apparatus accordingly.

In some embodiments, the controller 1250 can be programmed or programmable to generate the two-dimensional projection 1800 and/or to calculate or select a target value and/or mean value of the ratio of the volume of formulation per unit of area of the two-dimensional projection 1800.

Application of drops 175 of the formulation by a microvalving apparatus 1610 in a constant density vis-à-vis the two-dimensional projection is shown schematically in FIG. 14, although for the sake of clarity it should be noted again that the two-dimensional projection is a virtual one. The drops 175 are actually applied to the curved surface 1100, albeit being applied in a density or, equivalently, frequency, determined by the area of the two-dimensional projection 1800. As one can understand from the schematically illustrated geometry, the surface area of the curved surface 1110 is larger than the two-dimensional projection. Furthermore, the divergence of the area of the curved surface 1110 from that of the two-dimensional projection 1800 is larger in peripheral sections of the optical substrate 1100 than in central areas for the single-vision convex lens surface shown in the non-limiting example of FIGS. 13A-14. As is known, the degree of divergence of the area of the curved surface 1110 from that of the two-dimensional projection 1800 can be determined by the curve geometry of the curved surface, e.g., from curve geometry parameters such as the sagitta 180 of the surface 1110, the radius in the case of a spherical curve, and so on. Moreover, the actual density, i.e. the volume of formulation actually applied on the actual curved surface 1110 per unit of area of the curved surface 1110, is, typically, inversely proportional to the ratio of the area of the curved surface 1110 to the area of the two-dimensional projection, and this applies to any subdivision of the surface 1110 as well.

Accordingly, in some embodiments, depositing the formulation in a manner or distribution suitable to the particular formulation and curve geometry can be accomplished without requiring the application process to take into account the curve geometry when selecting or calculating a density of the application. Moreover, in some embodiments, the application of the formulation can cover an area greater than the surface of the optical substrate without requiring the application process to take into account other geometric parameters, such as the diameter or shape of the optical substrate.

FIG. 15 schematically shows an annular section 1150 at the periphery of an exemplary optical substrate 1100, which can be useful for characterizing the divergence of the area of the curved surface 1110 of the optical substrate 1100 from the corresponding area of the two-dimensional projection 1800, as well as for characterizing the reduced actual density on the actual curved surface 1110 as a function of distance from the center. In this non-limiting example, the annular section 1150 describes the area characterized by falling between 90% and 100% of the distance from a centroid of the optical substrate 1100 to the edge 1151. In an exemplary embodiment, the microvalving of the drops 175 of the formulation is controlled by the controller 1250 such that a ratio of a mean volume of formulation applied per unit of area of the curved surface 1110 in the outer annulus 1150 characterized by lying between 90% and 100% of a distance from a centroid of the curved surface 1110 and the perimeter 1151, is typically between 0.6 and 0.97 or 0.6 and 0.96 or 0.6 and 0.94 times a maximum ratio of a volume of formulation applied per unit of area of the curved surface 1100.

Referring now to FIG. 16, a virtual tangent line 1111 (or plane) is drawn at point (x,y) on the curved surface 1110 of the optical substrate 1110. The tangent line can be used to characterize the angle α of curved surface 1110, e.g., relative to the horizontal, and to describe the localized divergence of the area of the actual curved surface 1110 from the corresponding localized portion of the virtual two-dimensional projection 1800. In embodiments, the angle α can be between 5° and 50°, or between 10° and 40°, or between 5° and 20°, or between 20° and 50°, or within any intervening range between 5° and 50°. In embodiments, the microvalving of the drops 175 of the formulation is such that a ratio of a mean volume of formulation applied per unit of area of the curved surface 1110 at a given point on the surface 1110, is equal to a reduction factor times a maximum ratio of a volume of formulation applied per unit of area at any point on the surface 1100, said reduction factor being equal to a cosine of the acute angle α formed between (i) a plane or line 1111 that is tangent to the curved surface 1110 at said given point and (ii) a horizontal plane.

All mentions of a horizontal plane herein refer to a plane horizontal to a floor, and tangent planes or angles refer to planes or angles when the optical substrate is at rest on a horizontal surface.

In a first example, an optical substrate 1100 such as a lens blank has a front surface characterized by a base curve of 6.00 diopter. The lens blank has a diameter of 60 mm and a SAG number of 5.25 mm. A virtual tangent line 1111 (or plane) drawn at a point on the edge of the curved surface 1110 forms an angle α of 19.9° relative to the horizontal plane. The divergence of the area of the curved surface 1110 from that of the two-dimensional projection 1800 is such that at the point on the perimeter 1151 of the curved surface 1110, the area of the curved surface 1110 is 6.3% larger than at the corresponding point on the two-dimensional projection 1800. The area of outer annulus 1150 characterized by lying between 90% and 100% of a distance from the centroid of the curved surface 1110 and the perimeter 1151 is proportionally 5.6% to 5.7% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a second example, an optical substrate 1100 such as a lens blank has a front surface characterized by a base curve of 4.00 diopter. The lens blank has a diameter of 80 mm and a SAG number of 6.2 mm. A virtual tangent line 1111 (or plane) drawn at a point on the edge of the curved surface 1110 forms an angle α of 17.6° relative to the horizontal plane. The divergence of the area of the curved surface 1110 from that of the two-dimensional projection 1800 is such that at the point on the perimeter 1151 of the curved surface 1110, the area of the curved surface 1110 is 4.9% larger than at the corresponding point on the two-dimensional projection 1800. The area of outer annulus 1150 characterized by lying between 90% and 100% of a distance from the centroid of the curved surface 1110 and the perimeter 1151 is proportionally 4.4% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a third example, an optical substrate 1100 such as a lens blank has a front surface characterized by a base curve of 10.00 diopter. The lens blank has a diameter of 70 mm and a SAG number of 13.2 mm. A virtual tangent line 1111 (or plane) drawn at a point on the edge of the curved surface 1110 forms an angle α of 41.3° relative to the horizontal plane. The divergence of the area of the curved surface 1110 from that of the two-dimensional projection 1800 is such that at the point on the perimeter 1151 of the curved surface 1110, the area of the curved surface 1110 is 33.2% larger than at the corresponding point on the two-dimensional projection 1800. The area of outer annulus 1150 characterized by lying between 90% and 100% of a distance from the centroid of the curved surface 1110 and the perimeter 1151 is proportionally 28.5 to 28.6% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a fourth example, an optical substrate 1100 such as a lens blank has a front surface characterized by a base curve of 6.00 diopter. The lens blank has a diameter of 80 mm and a SAG number of 9.6 mm. A virtual tangent line 1111 (or plane) drawn at a point on the edge of the curved surface 1110 forms an angle α of 26.9° relative to the horizontal plane. The divergence of the area of the curved surface 1110 from that of the two-dimensional projection 1800 is such that at the point on the perimeter 1151 of the curved surface 1110, the area of the curved surface 1110 is 12.2% larger than at the corresponding point on the two-dimensional projection 1800. The area of outer annulus 1150 characterized by lying between 90% and 100% of a distance from the centroid of the curved surface 1110 and the perimeter 1151 is proportionally 10.8% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

In a fifth example, an optical substrate 1100 such as a lens blank has a front surface characterized by a base curve of 8.00 diopter. The lens blank has a diameter of 80 mm and a SAG number of 13.4 mm. A virtual tangent line 1111 (or plane) drawn at a point on the edge of the curved surface 1110 forms an angle α of 37.10 relative to the horizontal plane. The divergence of the area of the curved surface 1110 from that of the two-dimensional projection 1800 is such that at the point on the perimeter 1151 of the curved surface 1110, the area of the curved surface 1110 is 25.4% larger than at the corresponding point on the two-dimensional projection 1800. The area of outer annulus 1150 characterized by lying between 90% and 100% of a distance from the centroid of the curved surface 1110 and the perimeter 1151 is proportionally 22.1 to 22.2% larger than the corresponding outer annulus on the two-dimensional projection 1800 than is an inner region characterized by lying between 0% and 10% of a distance from the centroid of the curved surface 1110 and the perimeter 1151 with respect to a corresponding inner region on the two-dimensional projection 1800.

### EXAMPLES

Reference is now made to the following examples, which together with the above description, illustrate the invention in a non-limiting fashion.

### Materials

### Lens Materials

polycarbonate, a thermoplastic polymer
Trivex® (PPG), a urethane-based thermoset polymer
CR-39® (PPG), a thermoset polymer made from allyl diglycol carbonate

### Dyes for Water-Based Formulations:

| Dye Name | CAS# | Supplier |
|---|---|---|
| Basic Blue 9 | 122965-43-9 | Fast Colours LLP |
| Basic Yellow 2 | 2465-27-2 | Dixon Chew |
| Acid Green 25 | 4403-90-1 | Fast Colours LLP |
| Acid Red 33 | 3567-66-6 | Fast Colours LLP |
| Basic Orange 2 | 532-82-1 | Dixon Chew |
| Direct Black 168 | 85631-88-5 | Fast Colours LLP |

### Photochromic Dyes (Powders, James Robinson Specialty Ingredients Ltd.):

Reversacol Amazon Green
Reversacol Midnight Gray
Reversacol Leather Brown
Reversacol Corn Yellow
Reversacol Ocean Blue

### Liquid Softening Agents

Emoltene™ 3GO (Perstorp)—triethylenglycol-mono-2-ethyl-hexanoate
Pevalen (Perstorp)—pentaerythritol tetra valerate (PETV)
Jayflex™ DIDP—diisodecyl phthalate—(Exxon Mobile)
Jayflex™ L9TM—tri-nonyl trimellitate (Exxon Mobile)
Jayflex™ MB 10—iso-decyl benzoate (Exxon Mobile)
DEHP—di-2-ethylhexyl phthalate (Arkema)
DEHTP—di-2-ethylhexyl terephthalate (Arkema)
Palatinol N—diisononyl phthalate (BASF)
Palatinol 10-P—di-2-propylheptyl phthalate (BASF)
Paraplex® A-8000—low molecular weight polyester adipate (Hallstar)
Paraplex® A-8200—medium molecular weight polyester adipate (Hallstar)

### Thermoplastic Resins (Solvent-Soluble)

Pearlcoat™ DIPP 119—Aromatic polycaprolactone copolyester-based thermoplastic polyurethane (TPU) (Lubrizol)
Mowital® BA20S polyvinyl acetal (Kuraray) 14-18% polyvinyl alcohol, 1-4% polyvinyl acetate, dynamic viscosity 24-30 cP; Glass transition temperature 84-93° C. (DIN EN ISO 11357-1:2017-02).
Pearlbond™ 360—Polyether based thermoplastic polyurethane (TPU) (Lubrizol)
Pearlstick™ 47-60 linear thermoplastic polyurethane elastomers (Lubrizol)
SETALUX® 2127 XX-60—Thermoplastic acrylic resin having good adhesion to plastics (Allnex)
Polyvinyl butyral (or PVB) [also for primers and overcoats]
Laropal A-81—Thermoplastic aldehyde resin (BASF).

### Primers and Overcoats

### Acrylic Polymer Emulsions:

Joncryl® 1532—waterborne acrylic emulsion offering excellent adhesion to a wide variety of substrates including plastics (BASF); Primer
Joncryl® 1534—waterborne acrylic emulsion offering excellent adhesion to a wide variety of substrates including plastics (BASF); Primer
Joncryl® 2110—waterborne acrylic emulsion, styrene acrylate copolymer (BASF); Primer
Joncryl® 9530-A—waterborne acrylic emulsion self-crosslinking polymer designed for use in topcoats and primers; Overcoat
Joncryl® 617-A—waterborne acrylic polymer emulsion film forming overprint varnish formulations (BASF); Overcoat
SETALUX® 17-7202—acetoacetate functional acrylic resin combined with a ketimine resin (SETALUX® 10-1440) for primer; Overcoat
SETALUX® 17-1246—a fast-dry thermoplastic acrylic resin solution providing an excellent balance of hardness, adhesion and film toughness together with clarity and transparency; Overcoat

### PU Polymer Emulsions and Dispersions:

ALBERDINGK® APU 10600 self-crosslinking acrylic, PES/PC-polyurethane hybrid dispersion (Alberdingk Boley); Overcoat
Bondthane™ UD-620—self-crosslinking polyurethane is ideally suited for hard, clear or pigmented coatings for rigid plastics (BPI); Overcoat
CrystalCoat® PR 670—water-based emulsion (SDC); Primer
ALBERDINGK® U9800—solvent-free, aliphatic polyester polyurethane dispersion (Alberdingk Boley); Overcoat

### Resin Solvent Based Solutions:

Versamid® PUR 1010—Primer
Laroflex® HS-9000—Primer.

### Exemplary Solvents:

### Solvents: Very Low Evaporation Rate/Very Low Vapor Pressure at 25° C.

TPM (Tripropylene glycol methyl ether, CAS 25498-49-1)
PPH (Ph-O-CH2-CHMe-OH, CAS 770-35-4)
DBA (2-(2-Butoxyethoxy)ethyl acetate, CAS 124-17-4)
TPnB (Tripropylene glycol n-butyl ether, 55934-93-5)
DPnP (dipropylene glycol propyl ether, Pr—O—[CH2-CHMe-O]2-H, CAS 29911-27-1)
acetone glycerol (ALDRICH, 2,2-dimethyl-1,3-dioxolane-4-methanol, CAS 100-79-8)
butyl carbitol (CAS 112-34-5)
EGBE (ethylene glycol monobutyl ether, CAS 111-76-2)

### Solvents: High Evaporation Rate/High Vapor Pressure at 25° C.

n-butyl acetate
isobutyl acetate
methyl isobutyl ketone
isopropanol
ethanol

### Solvents: Very High Evaporation Rate/High Vapor Pressure at 25° C.

ethyl acetate
methyl propyl ketone
n-propyl acetate
isopropyl acetate
methyl ethyl ketone

### Equipment

Coating Equipment
   Ink-Jet Printer: Dimatix Materials Printer DMP-2831 equipped with a 10 pL Dimatix Materials Cartridge (Fujifilm Dimatix™ Inc); Ricoh gen4I mh2620, driven by GIS PMB C8 and hib-rh-384 (Ink feeding System: MegnaJet LabJet)
   Microvalve: electromagnetically actuated (Fritz Gyger AG); nozzle diameter—0.1 mm, pressure 0.5-2.0 bar
   Spin coater: MUTECH pCoater (Mutech Microsystems SAS)
   UV LED Curing System: FJ100 Gen 2, 395 nm, 12 W/cm² (Phoseon Technology)
   Thermal Curing System: Venticell ECO Forced air oven (MMM)
   Surface Activation: Corona Treatment Device Electrical Surface Treatment HF SpotTEC Single (Tantec).
Testing Equipment
   Spectrophotometer: Cary 4000 UV-Vis. double-beam spectrophotometer, ISO/EN 8980-3:2013 (Agilent)
   Light Transmittance and Haze Measuring Meter: TH-100, ASTM D1003/D1044 (Hangzhou CHN Spec Technology Co., Ltd.)
   Thickness measurements: ThetaMetrisis layer thickness analyzer.

### Example 1: Corona Surface Treatment Procedure

The head of the corona treatment device (Tantec) was set at 1 cm from the surface of the ophthalmic lens and then was activated for 10 seconds. The process was performed twice before various coating materials were applied on the ophthalmic lens.

### Example 2: Procedure for Primer Application Using Spin-Coating

The ophthalmic lens was attached to the vacuum chuck of the spin coating apparatus. The spinning of the ophthalmic lens was performed at a spinning speed of 3000 rpm, an acceleration of 1000 rpm/sec, for 10 seconds.

### Example 3: Procedure for Application of Post-Hardcoat Layers Using Spin-Coating

The ophthalmic lens was attached to the vacuum chuck of the spin coating apparatus. The spinning of the ophthalmic device was performed at a spinning speed of 1500 rpm, an acceleration of 500 rpm/sec, for 10 seconds.

### Example 4: Optimization of Ink-Jetting Parameters

In various ink application steps, ink-jetting may optionally be employed, utilizing ink-jet ink formulations. A Ricoh print head was used, typically with pre-heating to 40° C. The drop characteristics were then optimized for each ink using a Jet Expert stroboscope (Image Expert) mounted on the printer (camera and light source synchronized with the jetting frequency). The waveform was optimized for each ink-jet ink, jetted at a frequency of 0.5-3 kHz. The distance between the printhead and the substrate was 0.6-1.0 mm. The resolution was set at 300 dots per inch (dpi).

### Example 5: Microvalving a Film-Forming Ink onto a Lens Substrate

An optical construction having at least one of various functionalities (primer, tinting inks, photochromic inks, overcoats, hardcoats, post-hardcoat coatings, etc.) was prepared by microvalving a film-forming ink onto a lens substrate using an electromagnetically actuated microvalve (Fritz Gyger AG) having a nozzle diameter of 0.1 mm. The microvalve was mounted on a controllable X-Y-Z stage, with a PLC synchronizing between the actuation of the microvalve and the positioning of the lens. Both frequency and relative velocity between the stage and the microvalve were maintained at fixed values. The microvalving was performed according to any one of various pre-determined digital patterns.

### Example 6A: Drying

Drying of the primer, overcoat, tinting ink, and photochromic ink was typically performed at 60° C. for 30 minutes, unless otherwise indicated.

### Example 6B: Thermal Curing

Curing of the hardcoat (inner, when utilized, and outer) was typically performed at 120° C. for 3 hours.

### Example 6C: UV Curing

UV curing was performed for 10 seconds using the UV LED Curing System: FJ100 Gen 2, 395 nm, 12 W/cm² (Phoseon Technology).

### Example 6D: Aqueous Dye Concentrate Solution

One or more water-soluble dyes are slowly introduced to a stirred vessel containing water. The vessel is stirred for 60 minutes after the last of the dye has been added, to produce the aqueous dye concentrate in which the dye is fully dissolved.

### Example 6E: Aqueous Ink Formulation

To a stirred vessel containing an aqueous dye concentrate solution (e.g., prepared according to Example 6D) is added a water-based formulation containing a film-forming polymer selected to exhibit a low MFFT within the final aqueous ink formulation. After stirring for several minutes, typically at room temperature, a surfactant may be added, while stirring, and the stirring is continued for another 20 minutes.

### Example 6F: Aqueous Ink Formulation

To a stirred vessel containing an aqueous dye concentrate solution (e.g., prepared according to Example 6D) is added a water-based formulation containing fine, film-forming polymer particles selected to exhibit a low MFFT within the final aqueous ink formulation. After stirring for several minutes, typically at room temperature, one or more solvents and surfactants may be added, while stirring, and the stirring is continued for another 20 minutes to produce an aqueous dispersion.

### Example 6G: Aqueous Ink Formulation

To a stirred vessel containing water, a water-soluble dye and a water-soluble or dispersible resin (binder) are added and stirred until full dissolution (or dispersion of the resin) is obtained. While stirring, typically at room temperature, one or more solvents and surfactants may be added, with stirring continuing for another 60 minutes.

### Example 7

29 grams of DBA (2-(2-Butoxyethoxy)ethyl acetate) solvent were mixed with 66.6 grams of propylene glycol methyl ether solvent in a 200 ml glass beaker equipped with a magnetic stirrer. After mixing the components for 5 minutes at room temperature, 0.2 grams of surfactant BYK®-333 were added to the solvent mixture while mixing. 2 grams of Reversacol Midnight Gray dye were then added, along with 2.2 grams of Pearlbond™ 360, while mixing. Mixing was continued for another 20 minutes at 60° C. to produce the photochromic ink, which was subsequently filtered with a syringe filter (0.45 micrometer).

### Example 8

22 grams of DBA solvent were mixed with 72.3 grams of DPnP solvent in a 200 ml glass beaker equipped with a magnetic stirrer. After mixing the components for 5 minutes, 0.15 grams of surfactant BYK®-346 and 1.45 grams of Emoltene™ 3GO were added to the solvent mixture while mixing. 2 grams of Reversacol Amazon Green dye, were then added, along with 2.1 grams of Mowital® B 30 HH resin, while mixing. Mixing was continued for another 20 minutes at 60° C. to produce the photochromic ink, which was subsequently filtered with a syringe filter (0.45 micrometer).

### Example 9

An aqueous dye concentrate solution was prepared in accordance with Example 6D, containing yellow dye (10%) dissolved in water (90%). An aqueous dispersion was then prepared using this dye concentrate, according to Example 6F, using CrystalCoat™ PR-670 water based formulation containing 64-74% water, 2-7% ethylene glycol mono butyl ether, 10-20% N-methyl-2pyrrolidone, and about 12% polymer (polyurethane) solids. The aqueous dispersion contained 20 grams of the aqueous dye concentrate solution, 79.5 grams of the CrystalCoat™ PR-670 and 0.5 grams BYK®-346.

### Example 9A

An aqueous dye concentrate solution was prepared in accordance with Example 6D, containing black (Direct Black 168) dye (5.7%) dissolved in water (94.3%). An aqueous dispersion (emulsion) was then prepared using this dye concentrate, according to Example 6F, using Carboset®3119 acrylic dispersion. The aqueous dispersion contained 52.5 grams of the aqueous dye concentrate solution, 20 grams of Carboset® 3119, 11.5 grams of 2-butoxyethanol solvent, 15 g of TPM solvent and 1 gram of Surfynol 465 surfactant.

### Example 9B

An aqueous dye concentrate solution was prepared in accordance with Example 6D, containing blue (Basic Blue 9) dye (4.8%) dissolved in water (95.2%). An aqueous dispersion (emulsion) was then prepared using this dye concentrate, according to Example 6F, using Joncryl LMV 7034 acrylic dispersion. The aqueous dispersion contained 53 grams of the aqueous dye concentrate solution, 25 grams of Joncryl LMV 7034, 6 grams of 2-butoxyethanol solvent, 15 grams of TPM solvent and 1 gram of Surfynol 465 surfactant.

### Example 9C

An aqueous dye concentrate solution was prepared in accordance with Example 6D, containing black (Direct Black 168) dye (5.7%) dissolved in water (94.3%). An aqueous dispersion (emulsion) was then prepared using this dye concentrate, according to Example 6F, using Carboset®3119 acrylic dispersion. The aqueous dispersion contained 52.5 grams of the aqueous dye concentrate solution, 20 grams of Carboset® 3119, 12 grams of 2-butoxyethanol solvent, and 15.5 g of TPM solvent.

### Example 9D

An aqueous dye concentrate solution was prepared in accordance with Example 6D, containing blue (Basic Blue 9) dye (4.8%) dissolved in water (95.2%). An aqueous dispersion (emulsion) was then prepared using this dye concentrate, according to Example 6F, using Joncryl LMV 7034 acrylic dispersion. The aqueous dispersion contained 53 grams of the aqueous dye concentrate solution, 25 grams of Joncryl LMV 7034, 6.3 grams of 2-butoxyethanol solvent, and 15.7 grams of TPM solvent.

### Example 10

Aqueous dye concentrate solutions were prepared in accordance with Example 6D, containing Basic Yellow 2 dye (10%) dissolved in water (90%), Basic Blue 9 dye (10%) dissolved in water (90%), Acid Red 33 dye (10%) dissolved in water (90%), and Direct Black 168dye (10%) dissolved in water (90%). An aqueous dispersion was then prepared using these dye concentrates, according to Example 6F, using CrystalCoat™ PR-670. The aqueous dispersion contained 5.3 grams of the yellow concentrate, 1 gram of the blue concentrate, 2.5 grams of the red concentrate, 5 grams of the black concentrate, 85.7 grams of the CrystalCoat™ PR-670 and 0.5 grams BYK®-3481.

### Example 11

Aqueous dye concentrate solutions were prepared in accordance with Example 6D, containing Basic Yellow 2 dye (10%) dissolved in water (90%) and Acid Red 33 dye dye (10%) dissolved in water (900%). An aqueous dispersion was then prepared using these dye concentrates, according to Example 6F, using CrystalCoat™ PR-670. The aqueous dispersion contained 8.7 grams of the yellow concentrate and 5.2 grams of the red concentrate, 85.7 grams of the CrystalCoat™ PR-670 and 0.4 grams BYK®-3481.

### Examples 11A-11E

| | | | Ink | Ink | Ink | Ink | Ink |
|---|---|---|---|---|---|---|---|
| Composition | description | supplier | 11A | 11B | 11C | 11D | 11E |
| HYDRO- | Acrylic resin | Lawter | 5% | — | — | — | — |
| REZTM 2007E | | | | | | | |
| HYDRO- | Acrylic resin | Lawter | — | 5% | — | — | — |
| REZTM 2710E | | | | | | | |
| REACTOLTM 5145A | Polyester resin | Lawter | — | — | 5% | — | — |
| PVP K120 | Poly- | Ashland | — | — | — | 5% | — |
| | vinylpyrrolidone | | | | | | |
| Eastek(TM) 1400 | aqueous dispersion | Eastman | — | — | — | — | 20% |
| 30% in water | (not emulsion) of a | | | | | | |
| | sulfopolyester | | | | | | |
| | polymer | | | | | | |
| Basic Blue 9 | Water soluble dye | Fast | 2.5% | — | — | — | — |
| | | Colours | | | | | |
| | | LLP | | | | | |
| Basic Yellow 2 | Water soluble dye | Dixon | — | 3% | — | — | — |
| | | Chew | | | | | |
| Acid Green 25 | Water soluble dye | Fast | — | | 2% | — | — |
| | | Colours | | | | | |
| | | LLP | | | | | |
| Acid Red 33 | Water soluble dye | Fast | — | — | | 2.5% | — |
| | | Colours | | | | | |
| | | LLP | | | | | |
| Basic Orange 2 | Water soluble dye | Dixon | — | — | — | — | 3.5% |
| | | Chew | | | | | |
| Water | DI water | — | 56.5% | 56% | 52% | 51.5 | 40.5 |
| 2-butoxyethanol | Solvent | Dow | 20% | 20% | — | — | — |
| (butyl cellosolve CAS | | | | | | | |
| 111-76-2 | | | | | | | |
| Propylene glycol | Solvent | Solventis | — | — | 25% | 25% | 25% |
| methyl ether (1- | | | | | | | |
| Methoxy-2-Propanol | | | | | | | |
| CAS 107-98-2) | | | | | | | |
| TPM(Tripropylene | Solvent | Dow | 15% | 15% | 15% | 15% | 10% |
| glycol methyl ether, | | | | | | | |
| CAS 25498-49-1) | | | | | | | |
| Surfynol 465 | Surfactant | Evonik | 1% | 1% | — | — | — |
| Surfynol 485 | Surfactant | Evonik | — | — | 1% | 1% | 1% |

A series of water-based inks containing dissolved resins was prepared according to Example 6G while using the quantities described in Examples 11A-11E of the above-provided table.

### Example 12

39.54 grams of TPM solvent were heated to 80° C. and mixed in a 150 ml glass beaker equipped with a magnetic stirrer. 6.98 grams of BA20S polymer were gradually added to the heated solvent, while stirring. The beaker was covered with aluminum foil and mixed under heating for 8 hours. After 8 hours the mixture was clear and homogenous, the temperature was lowered to 70° C., and the following components were added during stirring: TPM solvent (4.8 grams); PMA solvent (44.34 grams); and dye mixture, composed of pre-mixed: solvent red 122 (0.35 grams), solvent yellow 82 (0.23 grams), and solvent black 27 (0.66 grams).

After mixing the components for 1 hour, the ink was removed, cooled down to room temperature, and filtered with a syringe filter (0.45 micrometer).

### Example 13

45.0 grams of TPM solvent were heated to 80° C. and mixed in a 150 ml glass beaker equipped with a magnetic stirrer. 5.0 grams of BA20S polymer were gradually added to the heated solvent, while stirring. After 8 hours of mixing as in Example 12, the temperature was lowered to 70° C., and the following components were added during stirring: TPM solvent (2.0 grams); PMA solvent (46.95 grams); and the dye mixture of Example 12 (1.05 grams). Processing then ensued as in Example 12.

### Example 14

45.0 grams of TPM solvent were heated to 80° C. and mixed in a 150 ml glass beaker equipped with a magnetic stirrer. 5.0 grams of BA20S polymer were gradually added to the heated solvent, while stirring. After 8 hours of mixing as in Example 12, the temperature was lowered to 70° C., and the following components were added during stirring: ethyl acetate solvent (24.5 grams); PMA solvent (24.5 grams); and the dye mixture of Example 12 (1.05 grams). Processing then ensued as in Example 12.

### Example 15

44.97 grams of TPM solvent were heated to 80° C. and mixed in a 150 ml glass beaker equipped with a magnetic stirrer. 5.0 grams of BA20S polymer were gradually added to the heated solvent, while stirring. After 8 hours of mixing as in Example 12, the temperature was lowered to 70° C., and the following components were added during stirring: ethyl acetate solvent (34.6 grams); PMA solvent (14.53 grams); and the dye mixture of Example 12 (0.9 grams). Processing then ensued as in Example 12.

### Example 16

45.0 grams of TPM solvent were heated to 80° C. and mixed in a 150 ml glass beaker equipped with a magnetic stirrer. 5.0 grams of BA20S polymer were gradually added to the heated solvent, while stirring. After 8 hours of mixing as in Example 12, the temperature was lowered to 70° C., and the following components were added during stirring: TPM solvent (8.10 grams); ethyl acetate solvent (40.85 grams); and the dye mixture of Example 12 (1.05 grams). Processing then ensued as in Example 12.

### Example 17

45.0 grams of TPM solvent were heated to 80° C. and mixed in a 150 ml glass beaker equipped with a magnetic stirrer. 5.0 grams of BA20S polymer were gradually added to the heated solvent, while stirring. After 8 hours of mixing as in Example 12, the temperature was lowered to 70° C., and the following components were added during stirring: TPM solvent (1.98 grams); ethyl acetate solvent (46.98 grams); and the dye mixture of Example 12 (1.05 grams). Processing then ensued as in Example 12.

### Example 18

22 grams of DBA solvent were mixed with 72.3 grams of DPnP solvent in a 200 ml glass beaker equipped with a magnetic stirrer. After mixing the components for 5 minutes, 0.15 grams of surfactant BYK®-346 and 1.45 grams of Emoltene™ 3GO were added to the solvent mixture while mixing. 2 grams of Reversacol Amazon Green dye, were then added, along with 2.1 grams of Mowital® B 30 HH resin, while mixing. Mixing was continued for another 20 minutes at 60° C. to produce the photochromic ink, which was subsequently filtered with a syringe filter (0.45 micrometer).

### Example 19

65 grams of Joncryl®1532 were mixed with 20 grams of water in a 200 ml glass beaker equipped with a magnetic stirrer. Then 9.5 grams of EB solvent, 4.8 grams of DPM solvent and 0.2 grams of BYK®024 were added while mixing. After mixing the components for 5 minutes, 0.5 grams of surfactant BYK®-346 were added to the mixture and the mixing was continued for another 10 minutes at 30° C., to produce a primer formulation.

### Example 20

70 grams of Joncryl®1534 were mixed with 15 grams of water in a 200 ml glass beaker equipped with a magnetic stirrer. Then 9.5 grams of EB solvent, 4.8 grams of DPM solvent and 0.2 grams of BYK®024 were added while mixing. After mixing the components for 5 minutes, 0.5 grams of surfactant EFKA®3200 were added to the mixture and the mixing was continued for another 10 minutes at 30° C., to produce a primer formulation.

### Example 21

75 grams of Joncryl®2110 were mixed with 10 grams of water in a 200 ml glass beaker equipped with a magnetic stirrer. Then 10 grams of EB solvent, 4.5 grams of DPM solvent and 0.25 grams of BYK®044 were added while mixing. After mixing the components for 5 minutes, 0.25 grams of surfactant BYK®346 were added to the mixture and the mixing was continued for another 10 minutes at 30° C., to produce a primer formulation.

### Example 22

2.0 grams of Mowital PVB 16H were mixed with 97.7 grams of ethyl acetate in a 200 ml glass flask equipped with a magnetic stirrer. After mixing the components for 30 minutes, 0.3 grams of surfactant BYK®-307 were added to the mixture and the mixing was continued for another 10 minutes at 30° C., to produce a primer formulation.

### Example 23

1.77 grams of Mowital PVB 30H were mixed with 98.2 grams of ethyl acetate in a 200 ml glass flask equipped with a magnetic stirrer. After mixing the components for 30 minutes, 0.3 grams of surfactant BYK®-307 were added to the mixture and the mixing was continued for another 10 minutes at 30° C., to produce a primer formulation.

### Example 24

2.0 grams of Pearlcoat™ DIPP 119 were mixed with 98 grams of ethyl acetate in a 200 ml glass flask equipped with a magnetic stirrer at 40° C. for 1 hour. After mixing the components for 60 minutes, 0.3 grams of surfactant BYK®-307 were added to the mixture and the mixing was continued for another 20 minutes to produce a primer formulation.

### Example 25

2.0 grams of Pearlstick™ 47-60 were mixed with 98 grams of ethyl acetate in a 200 ml glass flask equipped with a magnetic stirrer at 40° C. for 1 hour. After mixing the components for 60 minutes, 0.3 grams of surfactant BYK®-307 were added to the mixture and the mixing was continued for another 20 minutes to produce a primer formulation.

### Example 26

80 grams of U9800 were mixed with 19.5 grams of water, and 0.5 gram of BYK 346 in a 200 ml glass flask equipped with a magnetic stirrer for 1 hour to produce an overcoat formulation.

### Example 27

The corona surface treatment procedure was performed on a Trivex® (PPG) lens, according to Example 1.

### Example 28

The corona surface treatment procedure was performed on a polycarbonate lens according to Example 1.

### Example 29

The corona surface treatment procedure of Example 1 was performed on a polycarbonate lens that was pre-coated with a hardcoat.

### Example 30

The corona surface treatment procedure of Example 1 was performed on a Trivex® (PPG) lens that was pre-coated with a hardcoat.

### Example 31

The corona surface treatment procedure of Example 1 was performed on a CR-39® (PPG) lens that was pre-coated with a hardcoat.

### Example 32

Onto a polycarbonate lens was applied Versamid® PUR 1010 as a primer. Microvalving was effected according to Example 5. The wet layer was then subjected to thermal drying and curing in a Venticell ECO forced air oven at 60° C. for 10 minutes and then at 100° C. for 10 minutes, to produce the primer layer.

### Example 33

Onto a polycarbonate lens was applied Laroflex® HS-9000 as a primer. Microvalving was effected according to Example 5. The wet layer was then subjected to thermal drying and curing in a Venticell ECO forced air oven at 60° C. for 10 minutes and then at 100° C. for 10 minutes, to produce a primer layer having a thickness of about 1.5 μm.

### Example 34

Onto a polycarbonate lens was applied the Joncryl®1534 formulation of Example 20 as a primer. Spin coating was effected according to Example 2, and a calculated wet thickness of 1.9 μm was obtained. The wet layer was then subjected to thermal drying and curing in a Venticell ECO forced air oven at 60° C. for 10 minutes and then at 100° C. for 10 minutes.

### Example 35

Onto the polycarbonate lens that had been corona-treated was applied the Joncryl®1534 formulation of Example 20 as a primer. Spin coating was effected according to Example 2. The wet layer was then subjected to thermal drying and curing in a Venticell ECO forced air oven at 60° C. for 10 minutes and then at 100° C. for 10 minutes.

### Example 36-37

### Microvalving a Photochromic Ink onto the Surface of the Lens

The photochromic dye formulation of Example 8, which also contains a a polymeric binder, and a non-volatile liquid softening agent, was microvalved onto a Trivex® lens (Example 30) and a CR-39® lens (Example 31) according to Example 5, and at a pressure maintained below 1 bar.

### Example 38

Onto the lens treated in Example 37 was microvalved the formulation produced in Example 9, producing a wet layer having a calculated average thickness (based on the amount of ink applied divided by the total area covered) of 45 μm. The wet layer was then subjected to thermal drying in a Venticell ECO forced air oven at 60° C. for 30 minutes. The dry (average calculated) thickness was about 5.4 μm.

### Example 39

Onto the lens treated in Example 37 was microvalved the formulation produced in Example 10, producing a wet layer having a calculated average thickness (based on the amount of ink applied divided by the total area covered) of 38 μm. The wet layer was then subjected to thermal drying in a Venticell ECO forced air oven at 60° C. for 30 minutes. The dry (average calculated) thickness was about 4.6 μm.

### Example 40

Onto the lens treated in Example 36 was microvalved the formulation produced in Example 11, producing a wet layer having a calculated average thickness (based on the amount of ink applied divided by the total area covered) of 53 μm. The wet layer was then subjected to thermal drying in a Venticell ECO forced air oven at 60° C. for 30 minutes. The dry (average calculated) thickness was about 6.4 μm.

### Example 41

Onto the coated CR-39® lens produced in Example 37 was microvalved the overcoat formulation of Example 26. The wet layer was then subjected to thermal drying in a Venticell ECO forced air oven at 60° C. for 30 minutes. The dry (average calculated) thickness was about 3.1 μm.

### Example 42

Onto the coated CR-39® lens produced in Example 38 was microvalved the overcoat formulation of Example 26. The wet layer was then subjected to thermal drying in a Venticell ECO forced air oven at 60° C. for 30 minutes.

### Examples 43-46: Hardcoat Varnish Formulation

### Example 43: Hardcoat Varnish

15.0 grams of 3-glycidoxypropyltrimethoxysilane, 33.6 grams of tetraethyl orthosilicate, 22.5 grams of itaconic acid and 24.8 grams of ethyl acetate were combined while being stirred for 10 minutes until a homogeneous mixture was achieved. 24.8 grams of water were added dropwise on top of the premixed silane solution by a peristaltic pump to make the resulting mixture. The mixture was then stirred for 12 hours to produce a coating composition.

### Example 44: HC Varnish+Nanoparticles

15.5 grams of 3-glycidoxypropyltrimethoxysilane, 25.5 grams of tetraethyl orthosilicate, 2.3 grams of itaconic acid and 23.2 grams of ethyl acetate were combined while being stirred for 20 minutes until a homogeneous mixture was achieved. 19.1 grams of water were added to 16.3 grams of Ludox HS-30 (Grace) nanosilica colloidal dispersion and mixed for 15 minutes and then it was added dropwise on top of the premixed silane solution by a peristaltic pump to make the resulting mixture. The mixture was then stirred for 24 hours to produce a coating composition.

### Example 45: HC Varnish+Silane Additive

12.0 gram of methyltrimethoxysilane (Gelest), 8.0 grams of 3-glycidoxypropyltrimethoxysilane (Gelest), 29.1 grams of tetraethyl orthosilicate (Merck), 22.5 grams of succinic anhydride (Merck) and 24.8 grams of isopropyl acetate (Dow) were combined while being stirred for 10 minutes until a homogeneous mixture was achieved. 24.8 grams of water were added dropwise on top of the premixed silane solution by a peristaltic pump to make the resulting mixture. The mixture was then stirred for 7 hours to produce a coating composition.

### Example 46: HC Varnish+Catalyst

1.5 gram of 10% w/w of potassium hydroxide water solution was added dropwise to 98.5 grams of the mixture from Example 37 and mixed for 15 hours.

### Example 47

Onto the coated polycarbonate lenses produced in Example 42 were microvalved the formulations of Examples 35-38 as hardcoats. The samples were then cured according to the procedure of Example 6B.

### Example 48

### Measuring Haze & % Transmittance

After calibrating the T-100 instrument, the Target lens was measured (uncoated reference lens). In Sample mode, the coated lens was then tested. The instrument then displayed the following results of the coated and uncoated lenses: % Transmittance, A % Transmittance, Haze, and A Haze. Lower delta values between the coated and uncoated lens indicate good optical clarity/transparency.

As used herein in the specification and in the claims section that follows, the term “percent”, or “%”, refers to percent by weight, unless specifically indicated otherwise.

As used herein in the specification and in the claims section that follows, the terms “anti-glare”, “anti-reflectance”; “anti-fog”; “hardcoat”; “ultraviolet absorber”; “photochromic”, “tinting” “blue-light absorber”, and the like, unless otherwise specified, are meant as used in the art of optical substrate coatings.

As used herein in the specification and in the claims section that follows, the term “anti-scratch”, with respect to a material such as a formulation or a coating, refers to a material whose dried and cured coating exhibits a haze value of less than 6%, using the following taber abrasion properties, according to ASTM D1004-08: CS 10 F wheel, 500 g Load, 500 cycles.

Alternatively, the term “anti-scratch”, with respect to a material such as a formulation or a coating, refers to a material whose Bayer number is at least 5 or at least 6 when using ASTM F735-21.

The term “ratio”, as used herein in the specification and in the claims section that follows, refers to a weight ratio, unless specifically indicated otherwise.

As used herein in the specification and in the claims section that follows, the term “non-volatile component”, with respect to a formulation or formulation on a lens/optical substrate, relates to the residue left after driving off some or all of the solvents and carrier liquids from the lens/optical surface after subjecting the lens/optical substrate, coated with the formulation, to oven-drying at 120° C. for 3 hours. The residue includes the solid particles within the formulation, along with dissolved solids that remain after the solvent has been removed.

As used herein in the specification and in the claims section that follows, the term “drying/curing” (e.g., of a formulation or layer) refers to drying or otherwise curing of the formulation or layer. It will be appreciated that for many types of formulations, thermal drying is a mechanism for effecting full curing.

As used herein in the specification and in the claims section that follows, the term “complete drying and curing” refers to complete removal of the liquid solvent/carrier along with 100% curing of the layer or coating.

As used herein in the specification and in the claims section that follows, the terms “fully curing” and “fully cured” (e.g., of a formulation or layer) refers to at least 85% curing of the polymeric material, as determined by a Konig hardness test according to ASTM D4366 Standard Test Methods for Hardness of Organic Coatings by Pendulum Damping Tests. Thus, for a reference polymer sheet that is 100% completely cured, having a Konig hardness of 80, the identical material that is “fully-cured” or has undergone “full curing” would have a Konig hardness within a range of 68 (0.85.80) to 80. Thus, the “fully cured” polymeric material has a minimum hardness coefficient (CH) of at least 0.85.

The “thickness” of a layer or a plurality of layers at a particular location is measured in the direction that is normal (N) to the lens substrate at that location.

Various types of thin-film thickness measurements are known to those of skill in the art. For example, single-spot thickness measurements may be performed by spectral reflectance or by spectroscopic ellipsometry.

In addition, mapping of thin-film surfaces and calculation of average thicknesses of such films may be performed using these techniques.

The “average thickness” of a wet layer may be determined as follows: when a volume of material vol covers a surface area of a surface having an area SA with a wet layer—the thickness of the wet layer is assumed to be vol SA. If the weight of the materials is known, vol may be calculated by dividing by the material's specific gravity. Typically, the specific gravity of the various coating materials may safely be approximated as 1.00.

The “average thickness” of a dried film may be calculated as follows: when a volume of material vol that is x % liquid, by weight, wets or covers a surface area SA of a surface, and all the liquid is evaporated away to convert the wet layer into a dry film, the thickness of the dry film is calculated as:

$$vol / {ρ}_{wet layer} ( 100 - x ) / ( SA \cdot {ρ}_{dry layer} )$$

where ρ_{wet layer} is the specific gravity of the wet layer and ρ_{dry layer} is the specific gravity of the dry layer. This calculation requires a knowledge of various properties of the wet coating material of the film, e.g., the specific gravity. As mentioned above, typically, the specific gravities generally may be assumed to be 1.

Similarly, an average diameter of drops such as jetted or microvalved drops (Ddrop) may be calculated by weighing a large number of the jetted drops, converting the total weight into volume using the specific gravity, dividing by the number of drops, and utilizing the equation relating spherical drop diameter to sphere volume: D=(6*V/π)^{1/3}.

It will be appreciated by those of skill in the art that the various layers disposed on the optical or ophthalmic surface (e.g., the lens surface) of the present invention are generally of a substantially even thickness, hence, the “average thickness” may be determined by evaluating one or more spot thicknesses on the film or layer.

As used herein in the specification and in the claims section that follows, the term “characteristic”, with respect to an ink dot dimension such as height, length or diameter, refers to the maximal value of that dot dimension. By way of example, for a square dot, 30 micrometers on a side, the characteristic diameter would be the diagonal, i.e., 30 2=42.4 micrometers. For a dot having some peaks on the top surface, distal to the optical substrate, the dot height would be the maximum height measured normal to the top surface of the substrate. For a plurality of dots, the characteristic dimension is the average of the characteristic dimension of the individual dots within the plurality.

As used herein in the specification and in the claims section that follows, the term “average”, with respect to a dimension of a plurality of dots such as the height, length or diameter thereof, refers to the arithmetic mean of that dimension, and is calculated using the characteristic dimension for each dot in the plurality.

As used herein in the specification and in the claims section that follows, the term “transparent”, typically with respect to a material, e.g., a material used in a coating, or as a substrate, may be determined according to ASTM D1003. Utilizing ASTM D1003, a material having a haze measurement of less than 2% and a total transmittance (Tt) of at least 85% is considered “transparent”. More typically, the haze is at most 1.5% or at most 1.0%. More typically, Tt is at least 90% or at least 95%. Yet more typically, the haze is at most 1.0% and Tt is at least 95%.

As used herein in the specification and in the claims section that follows, the term “liquid medium” and the like refers to a medium that is liquid at its temperature of use. For example, the liquid medium in an ink-jet ink jetted at 38° C. is a liquid at 38° C. A “liquid medium” is typically liquid at 25° C.

The term “ophthalmic formulation”, is meant to be understood as used in the art of ophthalmic substrate coatings.

The term “non-volatile”, e.g., with regard to a liquid softening agent, is meant to be understood as generally used in solvent-based formulations.

Similarly, the term “non-volatile content”, typically with respect to a formulation such as an ink formulation, is meant to be understood as generally used in solvent-based formulations. It is specifically meant to include high-boiling point liquids such as glycerol (290° C.).

As used herein, the term “film-forming”, typically with respect to a resin, polymer, or formulation, is meant to be understood as generally used in the art of ophthalmic substrate coatings. Typically, the dry film of the film-forming materials has an average or characteristic thickness ranging from 0.2 to 5 micrometers.

As used herein in the specification and in the claims section that follows, the term “softening agent” and the like is used essentially as understood in the art.

As used herein in the specification and in the claims section that follows, the term “liquid” refers to the state of the material at 25° C.

As used herein in the specification and in the claims section that follows, the terms “LLevap”, “Levap”, “Mevap”, “Hevap”, and “HHevap”, refer to volatile liquids falling within respective characteristic ranges of relative evaporation rates with respect to n-butyl acetate at 25° C. and atmospheric pressure, according to ASTM D3539. More particularly, the volatile liquids are divided into 5 categories, as follows:
LLevap<0.1 (e.g.: TPM, DPM, EB, NMP, DMSO, ethylene glycol monobutyl ether, DPM acetate)
0.1≤Levap<0.5 (e.g.: EEP, EP, PP, PMA, n-butyl proprionate, n-butanol, amyl acetate, water)
0.5≤Mevap<0.85 (e.g.: PM, isobutanol)
0.85≤Hevap<1.8 (e.g.: xylene, n-butyl acetate, isobutyl acetate, methyl isobutyl ketone, isopropanol, ethanol)
1.8≤HHevap (e.g.: toluene, methanol, n-propyl acetate, isopropyl acetate, ethyl acetate, methyl propyl ketone, methyl ethyl ketone).

The designated standard material, n-butyl acetate, is assigned a vaporization or evaporation rate of 1.0. Thus, the term “relative evaporation rate” and the like is used with reference to n-butyl acetate.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

As used herein in the specification and in the claims section that follows, the terms “top”, “bottom”, “above”, “below”, “upper”, “lower”, “height” and “side” and the like are utilized for convenience of description or for relative orientation, and are not necessarily intended to indicate an absolute orientation in space.

### Additional Embodiments

Various formulations, methods, optical constructions, and systems are disclosed herein. Additional Embodiments are provided hereinbelow.

### Method Embodiments

1. A method of producing an optical construction on an optical substrate, the method comprising:
(a) microvalving ink drops of an ink formulation containing at least one dissolved dye onto an optical surface of the optical substrate, to form a wet layer; and
(b) treating the wet layer to produce a dried or cured dye-containing layer on said optical surface;
   wherein optionally, said optical surface is a curved surface, and wherein optionally, said optical surface is a polymeric surface.
   2. The method of Embodiment 1, wherein said ink formulation is an aqueous ink formulation containing an aqueous solvent system.
   3. The method of Embodiment 1, wherein the ink formulation is an organic or solvent-based ink formulation containing an organic or solvent-based solvent system.
   4. The method of Embodiment 2, the aqueous ink formulation further containing a polymeric resin.
   5. The method of Embodiment 4, wherein the polymeric resin is dissolved within the aqueous ink formulation.
   6. The method of Embodiment 5, wherein the aqueous solvent system contains a single liquid phase.
   7. The method of Embodiment 4, wherein said polymeric resin is dispersed as particles within the aqueous ink formulation.
   8. The method of Embodiment 7, wherein the particles of said polymeric resin form an emulsion within the aqueous ink formulation.
   9. The method of Embodiment 3, wherein the organic or solvent-based ink formulation further contains a polymeric resin dissolved within the organic or solvent-based solvent system.
   10. The method of Embodiment 9, wherein the organic or solvent-based solvent system contains a single liquid phase.
   11. The method of any one of the preceding Embodiments, wherein said optical surface is said polymeric surface.
   12. The method of any one of the preceding Embodiments, wherein said optical surface is said curved surface.
   13. The method of Embodiment 12, wherein the SAG number of the optical substrate is defined by any of the features in system Embodiments 25 to 36.
   14. The method of any previous Embodiment, wherein the base curve of the optical substrate is at least 2.
   15. The method of Embodiment 14, wherein the base curve is at least 3.
   16. The method of Embodiment 14, wherein the base curve is at least 4.
   17. The method of Embodiment 14, wherein the base curve is at least 5.
   18. The method of Embodiment 14, wherein the base curve is at least 6.
   19. The method of Embodiment 14, wherein the base curve is at least 8.
   20. The method of any previous Embodiment, wherein the base curve of the optical substrate is at most 14.
   21. The method of Embodiment 20, wherein the base curve is at most 12.
   22. The method of Embodiment 20, wherein the base curve is at most 10.
   23. The method of any previous Embodiment, wherein for any point on the target surface, a an acute angle formed between (i) a plane that is tangent to the target surface at said given point and (ii) a horizontal plane is an angle (α), and wherein the maximum a on the target surface is αₘₐₓ, and wherein is αₘₐₓ is at least 5°.
   24. The method of Embodiment 23, wherein αₘₐₓ is at least 7°.
   25. The method of Embodiment 23, wherein αₘₐₓ is at least 10°.
   26. The method of Embodiment 23, wherein αₘₐₓ is at least 13°.
   27. The method of Embodiment 23, wherein αₘₐₓ is at least 16°.
   28. The method of Embodiment 23, wherein αₘₐₓ is at least 19°.
   29. The method of Embodiment 23, wherein αₘₐₓ is at least 23°.
   30. The method of Embodiment 23, wherein αₘₐₓ is at least 26°.
   31. The method of Embodiment 23, wherein αₘₐₓ is at least 310, at least 34°, or at least 40°.
   32. The method of any of Embodiments 23 to 31, wherein αₘₐₓ is at most 50°.
   33. The method of Embodiment 32, wherein αₘₐₓ is at most 42°.
   34. The method of Embodiment 32, wherein αₘₐₓ is at most 37°.
   35. The method of any one of the preceding Embodiments, wherein said ink formulation is a film-forming formulation.
   36. The method of claim 35, wherein a minimum film-forming temperature (MFFT) of said polymer is at most 60° C.
   37. The method of Embodiment 36, wherein said MFFT of said polymer is at most 50° C.
   38. The method of Embodiment 37, wherein said MFFT of said polymer is at most 45° C.
   39. The method of Embodiment 37, wherein said MFFT of said polymer is at most 40° C.
   40. The method of Embodiment 37, wherein said MFFT of said polymer is at most 35° C.
   41. The method of Embodiment 37, wherein said MFFT of said polymer is at most 30° C.
   42. The method of Embodiment 37, wherein said MFFT of said polymer is at most 25° C.
   43. The method of Embodiment 37, wherein said MFFT of said polymer is at most 20° C.
   44. The method of Embodiment 37, wherein said MFFT of said polymer is at most 15° C.
   45. The method of any one of Embodiments 36 to 44, wherein the MFFT of said polymer is at least −50° C.
   46. The method of Embodiment 45, wherein said MFFT of said polymer is at least −35° C.
   47. The method of Embodiment 45, wherein said MFFT of said polymer is at least −20° C.
   48. The method of Embodiment 45, wherein said MFFT of said polymer is at least −10° C.
   49. The method of any preceding Embodiment, wherein at least one of a thickness TH, characteristic thickness THc, and average thickness THav of the wet layer is at most 100 micrometers (μm).
   50. The method of Embodiment 49, wherein at least one of TH, THc and THav is at most 80 μm.
   51. The method of Embodiment 49, wherein at least one of TH, THc and THav is at most 70 μm.
   52. The method of Embodiment 49, wherein at least one of TH, THc and THav is at most 60 μm.
   53. The method of Embodiment 49, wherein at least one of TH, THc and THav is at most 50 μm.
   54. The method of any of Embodiments 49 to 53, wherein at least one of TH, THc, and THav is at least 10 μm.
   55. The method of Embodiment 54, wherein at least one of TH, THc, and THav is at least 18 μm.
   56. The method of Embodiment 54, wherein at least one of TH, THc, and THav is at least 25 μm.
   57. The method of Embodiment 54, wherein at least one of TH, THc, and THav is at least 30 μm.
   58. The method of Embodiment 54, wherein at least one of TH, THc, and THav is at least 35 μm.
   59. The method of Embodiment 54, wherein at least one of TH, THc, and THav is at least 40 μm.
   60. The method of Embodiment 54, wherein at least one of TH, THc, and THav is at least 45 μm.
   61. The method of any of Embodiments 49 to 60, wherein at least one of TH, THc, and THav includes TH.
   62. The method of any of Embodiments 49 to 60, wherein at least one of TH, THc, and THav includes THav.
   63. The method of any of Embodiments 49 to 60, wherein at least one of TH, THc, and THav includes TH and THav.
   64. The method of any of Embodiments 49 to 60, wherein at least one of TH, THc, and THav includes TH, THc, and THav.
   65. The method of any of Embodiments 49 to 58 and 61 to 64, wherein at least one of TH, THc and THav is at most 40 μm.
   66. The method of any of Embodiments 49 to 56 and 61 to 64, wherein at least one of TH, THc and THav is at most 30 μm.
   67. The method of any of Embodiments 49 to 66, wherein at least one of TH, THc, and THav is at least 4 μm.
   68. The method of Embodiment 47, wherein at least one of TH, THc and THav is at least 5.5 μm.
   69. The method of Embodiment 47, wherein at least one of TH, THc, and THav is at least 7 μm.
   70. The method of any preceding Embodiment, wherein, with respect to the ink drops, at least one of a drop volume Vd a characteristic drop volume Vd-c, and an average drop volume Vd-av is within a range of 4 to 400 nanoliters (nl).
   71. The method of Embodiment 70, wherein at least one of Vd, Vd-c and Vd-av is at least 5 nl.
   72. The method of Embodiment 70, wherein at least one of Vd, Vd-c and Vd-av is at least 6 nl.
   73. The method of Embodiment 70, wherein at least one of Vd, Vd-c and Vd-av is at least 8 nl.
   74. The method of Embodiment 70, wherein at least one of Vd, Vd-c and Vd-av is at least 10 nl.
   75. The method of Embodiment 70, wherein at least one of Vd, Vd-c and Vd-av is at least 12 nl.
   76. The method of Embodiment 70, wherein at least one of Vd, Vd-c and Vd-av is at least 15 nl.
   77. The method of any of Embodiments 70 to 76, wherein at least one of Vd, Vd-c and Vd-av is at most 250 nl.
   78. The method of Embodiment 77, wherein at least one of Vd, Vd-c and Vd-av is at most 100 nl.
   79. The method of Embodiment 77, wherein at least one of Vd, Vd-c and Vd-av is at most 70 nl.
   80. The method of Embodiment 77, wherein at least one of Vd, Vd-c and Vd-av is at most 50 nl.
   81. The method of Embodiment 77, wherein at least one of Vd, Vd-c and Vd-av is at most 45 nl.
   82. The method of Embodiment 77, wherein at least one of Vd, Vd-c and Vd-av is at most 40 nl.
   83. The method of Embodiment 77, wherein at least one of Vd, Vd-c and Vd-av is at most 35 nl.
   84. The method of Embodiment 77, wherein at least one of Vd, Vd-c and Vd-av is at most 30 nl.
   85. The method of Embodiment 77, wherein at least one of Vd, Vd-c and Vd-av is at most 25 nl.
   86. The method of Embodiment 77, wherein at least one of Vd, Vd-c and Vd-av is at most 22 nl.
   87. The method of Embodiment 77, wherein at least one of Vd, Vd-c and Vd-av is at most 20 nl.
   88. The method of Embodiment 77, wherein at least one of Vd, Vd-c and Vd-av is at most 18 nl.
   89. The method of Embodiment 77, wherein at least one of Vd, Vd-c and Vd-av is at most 16 nl.
   90. The method of any of Embodiments 70 to 89, wherein at least one of Vd, Vd-c and Vd-av includes Vd.
   91. The method of any of Embodiments 70 to 90, wherein at least one of Vd, Vd-c and Vd-av includes Vd-c.
   92. The method of any of Embodiments 70 to 91, wherein at least one of Vd, Vd-c and Vd-av includes Vd-av.
   93. The method of any of the preceding Embodiments, wherein said dispersed particles of polymer in said aqueous dye containing solution form a polyurethane dispersion.
   94. The method of any of Embodiments 1 to 92, wherein said dispersed particles of polymer in said aqueous dye containing solution form a polyurethane-acrylic dispersion.
   95. The method of any one of Embodiments 1 to 92, wherein said dispersed particles of polymer in said aqueous dye containing solution form a polycarbonate dispersion.
   96. The method of any one of Embodiments 1 to 92, wherein said dispersed particles of polymer in said aqueous dye containing solution form a polycarbonate-polyurethane dispersion.
   97. The method of any one of the preceding Embodiments, wherein a 25° C. viscosity of said ink formulation is at most 65 cP.
   98. The method of Embodiment 97, wherein said 25° C. viscosity is at most 50 cP.
   99. The method of Embodiment 97, wherein said 25° C. viscosity is at most 35 cP.
   100. The method of Embodiment 97, wherein said 25° C. viscosity is at most 25 cP.
   101. The method of Embodiment 97, wherein said 25° C. viscosity is at most 20 cP.
   102. The method of Embodiment 97, wherein said 25° C. viscosity is at most 15 cP.
   103. The method of Embodiment 97, wherein said 25° C. viscosity is at most 12 cP.
   104. The method of any one of Embodiments 97 to 103, wherein said 25° C. viscosity of said liquid film-forming formulation is at least 1.5 cP.
   105. The method of Embodiment 104, wherein said 25° C. viscosity is at least 2.5 cP.
   106. The method of Embodiment 104, wherein said 25° C. viscosity is at least 4 cP.
   107. The method of Embodiment 104, wherein said 25° C. viscosity is at least 6 cP.
   108. The method of any one of the preceding Embodiments, wherein said polymeric surface is or includes a thermoset polymer, said polymeric surface optionally coated with a hardcoat.
   109. The method of Embodiment 108, wherein said polymeric surface is coated with said hardcoat.
   110. The method of Embodiment 108 or 109, wherein said thermoset polymer is a urethane-based thermoset polymer such as Trivex®.
   111. The method of Embodiment 108 or 109, wherein said thermoset polymer is made from allyl diglycol carbonate, such as CR-39®.
   112. The method of any one of the previous Embodiments, wherein said polymeric surface is or includes a thermoplastic polymer, said polymeric surface optionally coated with a hardcoat.
   113. The method of Embodiment 112, wherein said polymeric surface is coated with said hardcoat.
   114. The method of Embodiment 112 or 113, wherein said thermoplastic polymer is a polycarbonate.
   115. The method of any one of the preceding Embodiments, wherein the non-volatile content of the ink formulation is at least 5%.
   116. The method of Embodiment 115, wherein the non-volatile content of the ink formulation is at least 7%.
   117. The method of Embodiment 115, wherein the non-volatile content of the ink formulation is at least 9%.
   118. The method of Embodiment 115, wherein the non-volatile content of the ink formulation is at least 10%.
   119. The method of Embodiment 115, wherein the non-volatile content of the ink formulation is at least 11%.
   120. The method of Embodiment 115, wherein the non-volatile content of the ink formulation is at least 12%.
   121. The method of any one of the preceding Embodiments, wherein the non-volatile content of the ink formulation is at most 20%.
   122. The method of Embodiment 121, wherein the non-volatile content of the ink formulation is at most 18%.
   123. The method of Embodiment 121, wherein the non-volatile content of the ink formulation is at most 16.5%.
   124. The method of Embodiment 121, wherein the non-volatile content of the ink formulation is at most 15.5%.
   125. The method of Embodiment 121, wherein the non-volatile content of the ink formulation is at most 15%.
   126. The method of Embodiment 121, wherein the non-volatile content of the ink formulation is at most 14.5%.
   127. The method of Embodiment 121, wherein the non-volatile content of the ink formulation is at most 14%.
   128. The method of any of the preceding Embodiments, wherein a weight ratio of liquid to polymer R_{P-L} within the ink formulation is at most 0.24.
   129. The method of Embodiment 128, wherein R_{P-L} is at most 0.22.
   130. The method of Embodiment 128, wherein R_{P-L} is at most 0.20.
   131. The method of Embodiment 128, wherein R_{P-L} is at most 0.18.
   132. The method of Embodiment 128, wherein R_{P-L} is at most 0.16.
   133. The method of Embodiment 128, wherein R_{P-L} is at most 0.14.
   134. The method of any of Embodiments 128 to 133, wherein R_{P-L} is at least 0.06.
   135. The method of Embodiment 134, wherein R_{P-L} is at least 0.08.
   136. The method of Embodiment 134, wherein R_{P-L} is at least 0.09.
   137. The method of Embodiment 134, wherein R_{P-L} is at least 0.095.
   138. The method of Embodiment 134, wherein R_{P-L} is at least 0.1.
   139. The method of Embodiment 134, wherein R_{P-L} is within a range of 0.075 to 0.15.
   140. The method of Embodiment 134, wherein R_{P-L} is within a range of 0.085 to 0.135.
   141. The method of Embodiment 134, wherein R_{P-L} is within a range of 0.09 to 0.13.
   142. The method of any one of the preceding Embodiments, wherein a 25° C. surface tension a of said ink formulation is most 35 dyne/cm.
   143. The method of Embodiment 142, wherein a is at most 32 dyne/cm.
   144. The method of Embodiment 142, wherein a is at most 30 dyne/cm.
   145. The method of Embodiment 142, wherein a is at most 29 dyne/cm.
   146. The method of any Embodiments 142 to 145, wherein a of said ink formulation is at least 24 dyne/cm.
   147. The method of Embodiment 146, wherein a is at least 25 dyne/cm.
   148. The method of Embodiment 146, wherein a is at least 26 dyne/cm.
   149. The method of any of the preceding Embodiments, wherein at least 85 weight % of the total polymer content within the ink formulation is a film-forming polymer.
   150. The method of any of the preceding Embodiments, wherein at least 90 weight % of the total polymer content within the ink formulation is a film-forming polymer.
   151. The method of any of the preceding Embodiments, wherein, on an n-butyl acetate normalized 25° C. evaporation rate scale, at least 50 weight % of the total solvent within the ink formulation is at most a high vapor-pressure (Hevap) solvent.
   152. The method of any of the preceding Embodiments, wherein, on an n-butyl acetate normalized 25° C. evaporation rate scale, at least 60 weight % of the total solvent within the ink formulation is at most a high vapor-pressure (Hevap) solvent.
   153. The method of any one of the preceding Embodiments, wherein, on an n-butyl acetate normalized 25° C. evaporation rate scale, at least 70 weight % of the total solvent within the ink formulation is at most a high vapor-pressure (Hevap) solvent.
   154. The method of any one of the preceding Embodiments, wherein, on an n-butyl acetate normalized 25° C. evaporation rate scale, at least 80 weight % of the total solvent within the ink formulation is at most a high vapor-pressure (Hevap) solvent.
   155. The method of any one of the preceding Embodiments, wherein, on an n-butyl acetate normalized 25° C. evaporation rate scale, at least 90 weight % of the total solvent within the ink formulation is at most a Hevap solvent.
   156. The method of any one of the preceding Embodiments, wherein, on an n-butyl acetate normalized 25° C. evaporation rate scale, at least 95 weight % of the total solvent within the ink formulation is at most a Hevap solvent.
   157. The method of any one of the preceding Embodiments, wherein, on an n-butyl acetate normalized 25° C. evaporation rate scale, at least 70 weight % of the total solvent within the ink formulation is at most a medium vapor-pressure (Mevap) solvent.
   158. The method of any one of the preceding Embodiments, wherein, on an n-butyl acetate normalized 25° C. evaporation rate scale, at least 75 weight % of the total solvent within the ink formulation is at most a Mevap solvent.
   159. The method of any one of the preceding Embodiments, wherein, on an n-butyl acetate normalized 25° C. evaporation rate scale, at least 80 weight % of the total solvent within the ink formulation is at most a Mevap solvent.
   160. The method of any one of the preceding Embodiments, wherein, on an n-butyl acetate normalized 25° C. evaporation rate scale, at least 85 weight % of the total solvent within the ink formulation is at most a Mevap solvent.
   161. The method of any one of the preceding Embodiments, wherein, on an n-butyl acetate normalized 25° C. evaporation rate scale, at least 90 weight % of the total solvent within the ink formulation is at most a Mevap solvent.
   162. The method of any one of the preceding Embodiments, wherein, on an n-butyl acetate normalized 25° C. evaporation rate scale, at least 55 weight % of the total solvent within the ink formulation is at most a low vapor-pressure (Levap) solvent.
   163. The method of Embodiment 162, wherein at least 60 weight % of the total solvent within the ink formulation is at most a Levap solvent.
   164. The method of Embodiment 162, wherein at least 65 weight % of the total solvent within the ink formulation is at most a Levap solvent.
   165. The method of Embodiment 162, wherein at least 70 weight % of the total solvent within the ink formulation is at most a Levap solvent.
   166. The method of Embodiment 162, wherein at least 80 weight % of the total solvent within the ink formulation is at most a Levap solvent.
   167. The method of Embodiment 162, wherein at least 90 weight % of the total solvent within the ink formulation is at most a Levap solvent.
   168. The method of any one of the preceding Embodiments, wherein, on an n-butyl acetate normalized 25° C. evaporation rate scale, at least 30 weight % of the total solvent within the ink formulation has a normalized evaporation rate of at most 0.35.
   169. The method of any one of the preceding Embodiments, wherein, on an n-butyl acetate normalized 25° C. evaporation rate scale, at least 40 weight % of the total solvent within the ink formulation has a normalized evaporation rate of at most 0.35.
   170. The method of any one of the preceding Embodiments, wherein, on an n-butyl acetate normalized 25° C. evaporation rate scale, at least 50 weight % of the total solvent within the ink formulation has a normalized evaporation rate of at most 0.35.
   171. The method of any one of the preceding Embodiments, wherein, on an n-butyl acetate normalized 25° C. evaporation rate scale, at least 60 weight % of the total solvent within the ink formulation has a normalized evaporation rate of at most 0.35.
   172. The method of any one of the preceding Embodiments, wherein, on an n-butyl acetate normalized 25° C. evaporation rate scale, at least 70 weight % of the total solvent within the ink formulation has a normalized evaporation rate of at most 0.35.
   173. The method of any one of the preceding Embodiments, wherein, on an n-butyl acetate normalized 25° C. evaporation rate scale, at least 75 weight % of the total solvent within the ink formulation has a normalized evaporation rate of at most 0.35.
   174. The method of any one of the preceding Embodiments, wherein, on an n-butyl acetate normalized 25° C. evaporation rate scale, at least 80 weight % of the total solvent within the ink formulation has a normalized evaporation rate of at most 0.4.
   175. The method of any one of the preceding Embodiments, wherein, on an n-butyl acetate normalized 25° C. evaporation rate scale, at least 90 weight % of the total solvent within the ink formulation has a normalized evaporation rate of at most 0.4.
   176. The method of any one of the preceding Embodiments, wherein the concentration of very low vapor-pressure (LLevap) solvent in the total solvent within the ink formulation is at least 20 weight %.
   177. The method of Embodiment 176, wherein the concentration of the LLevap solvent is at least 30 weight %.
   178. The method of Embodiment 176, wherein the concentration of the LLevap solvent is at least 35 weight %.
   179. The method of Embodiment 176, wherein the concentration of the LLevap solvent is at least 40 weight %.
   180. The method of Embodiment 176, wherein the concentration of the LLevap solvent is at least 45 weight %.
   181. The method of Embodiment 176, wherein the concentration of the LLevap solvent is at least 50 weight %.
   182. The method of Embodiment 176, wherein the concentration of the LLevap solvent is at least 55 weight %.
   183. The method of Embodiment 176, wherein the concentration of the LLevap solvent is at least 60 weight %.
   184. The method of Embodiment 176, wherein the concentration of the LLevap solvent is at least 65 weight %.
   185. The method of Embodiment 176, wherein the concentration of the LLevap solvent is at least 70 weight %.
   186. The method of Embodiment 176, wherein the concentration of the LLevap solvent is at least 75 weight %.
   187. The method of any one of Embodiments 176 to 186, wherein the normalized evaporation rate of the LLevap solvent is at most 0.05.
   188. The method of Embodiment 187, wherein the normalized evaporation rate of the LLevap solvent is at most 0.025.
   189. The method of Embodiment 187, wherein the normalized evaporation rate of the LLevap solvent is at most 0.015.
   190. The method of Embodiment 187, wherein the normalized evaporation rate of the LLevap solvent is at most 0.012.
   191. The method of any one of Embodiments 187 to 190, wherein the normalized evaporation rate of the LLevap solvent is at least 0.0015.
   192. The method of Embodiment 191, wherein the normalized evaporation rate of the LLevap solvent is at least 0.004.
   193. The method of any one of the preceding Embodiments, further comprising, prior to said microvalving ink drops of said ink formulation, subjecting said optical surface of the optical substrate to at least one surface treatment.
   194. The method of Embodiment 193, wherein said at least one surface treatment includes an energy treatment for raising the surface energy of said optical surface.
   195. The method of Embodiment 194, wherein said energy treatment includes at least one energy treatment selected from the group consisting of corona, plasma, electron beam and electrical discharge treatments.
   196. The method of any one of Embodiments 193 to 195, wherein said surface treatment raises the surface energy of the optical substrate by at least 2 mN/m.
   197. The method of Embodiment 196, wherein said surface treatment raises the surface energy of the optical substrate by at least 3 mN/m.
   198. The method of Embodiment 196, wherein said surface treatment raises the surface energy of the optical substrate by at least 5 mN/m.
   199. The method of Embodiment 196, wherein said surface treatment raises the surface energy of the optical substrate by at least 8 mN/m.
   200. The method of Embodiment 196, wherein said surface treatment raises the surface energy of the optical substrate by at least 12 mN/m.
   201. The method of any one of Embodiments 193 to 200, wherein said surface treatment raises the surface energy of the optical substrate by at most 40 mN/m.
   202. The method of Embodiment 201, wherein said surface treatment raises the surface energy of the optical substrate by at most 30 mN/m.
   203. The method of Embodiment 201, wherein said surface treatment raises the surface energy of the optical substrate by at most 20 mN/m.
   204. The method of Embodiment 201, wherein said surface treatment raises the surface energy of the optical substrate by at most 14 mN/m.
   205. The method of any one of Embodiments 193 to 204, wherein said surface treatment includes applying a primer to a first surface of the optical substrate to form a wet primer coating, and drying or curing said wet primer coating to form said optical surface of the optical substrate.
   205A. The method of Embodiment 205, wherein the curing the wet primer coating produces a fully-cured primer coating, prior to applying the dye-containing ink formulation.
   205B. The method of Embodiment 205A, wherein the fully-cured primer coating has a hardness coefficient (CH) of at least 0.9 or at least 0.95.
   205C. The method of Embodiment 205A or 205B, wherein the cured primer coating has a thickness (Tp) of at least 0.4 μm.
   205D. The method of Embodiment 205C, wherein Tp is at least 0.6 μm.
   205E. The method of Embodiment 205C, wherein Tp is at least 0.8 μm.
   205F. The method of Embodiment 205C, wherein Tp is at least 1.0 μm.
   205G. The method of any of Embodiments 205C to 205F, wherein Tp is at most 3 μm.
   205H. The method of Embodiment 205G, wherein Tp is at most 2.5 μm.
   2051. The method of Embodiment 205G, wherein Tp is at most 2.0 μm.
   205J. The method of Embodiment 205G, wherein Tp is at most 1.7 μm.
   205K. The method of Embodiment 205G, wherein Tp is at most 1.4 μm.
   205L. The method of any of Embodiments 205C to 205K, wherein Tp is at least one of a local thickness and an average thickness.
   205M. The method of any of Embodiments 205 to 205L, wherein the cured primer coating has a non-tacky upper surface.
   206. The method of any one of the preceding Embodiments, further comprising, after treating the wet layer to produce a dried dye-containing layer on said optical surface, applying a wet overcoat layer on top of the outer or exposed face of said dried dye-containing layer.
   207. The method of Embodiment 206, further comprising, drying or curing said wet overcoat layer to produce a dried or cured overcoat layer.
   208. The method of Embodiment 207, wherein the dried or cured overcoat layer has at least one of a local thickness and an average thickness of at least 4 μm.
   209. The method of Embodiment 208, wherein the at least one of the local thickness and the average thickness of the dried or cured overcoat layer is at least 5 μm.
   210. The method of Embodiment 208, wherein the at least one of the local thickness and the average thickness of the dried or cured overcoat layer is at least 6 μm.
   211. The method of Embodiment 208, wherein the at least one of the local thickness and the average thickness of the dried or cured overcoat layer is at least 7 μm.
   212. The method of any one of Embodiments 208 to 211, wherein the at least one of the local thickness and the average thickness of the dried or cured overcoat layer is at most 18 μm.
   213. The method of Embodiment 212, wherein the at least one of the local thickness and the average thickness of the dried or cured overcoat layer is at most 15 μm.
   214. The method of Embodiment 212, wherein the at least one of the local thickness and the average thickness of the dried or cured overcoat layer is at most 12 μm.
   215. The method of Embodiment 212, wherein the at least one of the local thickness and the average thickness of the dried or cured overcoat layer is at most 10 μm.
   216. The method of any one of the preceding Embodiments, applying a first liquid hardcoat formulation onto a currently exposed optical surface of the optical substrate, to form a first wet hardcoat layer.
   217. The method of Embodiment 216, further comprising curing said first wet hardcoat layer to form a first cured hardcoat layer.
   218. The method of Embodiment 216, wherein at least one of a local thickness and an average thickness of the first cured hardcoat layer is at least 2 μm.
   219. The method of Embodiment 216, wherein at least one of a local thickness and an average thickness of the first cured hardcoat layer is at least 2.5 μm.
   220. The method of Embodiment 216, wherein at least one of a local thickness and an average thickness of the first cured hardcoat layer is at least 3 μm.
   221. The method of Embodiment 216, wherein at least one of a local thickness and an average thickness of the first cured hardcoat layer is at least 3.5 μm.
   222. The method of any one of Embodiments 218 to 221, wherein the at least one of the local thickness and the average thickness of the first cured hardcoat layer is at most 7 μm.
   223. The method of any one of Embodiments 218 to 221, wherein the at least one of the local thickness and the average thickness of the first cured hardcoat layer is at most 6 μm.
   224. The method of any one of Embodiments 218 to 221, wherein the at least one of the local thickness and the average thickness of the first cured hardcoat layer is at most 5 μm.
   225. The method of any one of Embodiments 218 to 224, further comprising applying a second liquid hardcoat formulation onto a currently exposed optical surface of the optical substrate, to form a second wet hardcoat layer.
   226. The method of Embodiment 225, further comprising curing said second wet hardcoat layer to form a second cured hardcoat layer.
   227. The method of any one of the preceding Embodiments, wherein said optical surface is an ophthalmic surface.
   228. The method of any one of the preceding Embodiments, wherein said optical substrate is an ophthalmic substrate.
   229. The method of Embodiments 227 or 228, wherein said optical surface or ophthalmic surface is the front surface of the substrate.
   230. The method of Embodiments 227 or 228, wherein said optical surface or ophthalmic surface is the back surface of the substrate.
   231. The method of any one of Embodiments 227 or 230, wherein said optical surface or ophthalmic surface is a convex surface.
   232. The method of any one of Embodiments 227 or 230, wherein said optical surface or ophthalmic surface is a concave surface.
   233. The method of any one of the preceding Embodiments, wherein the direction of the relative movement between the nozzle of the microvalving apparatus and the optical substrate is in the XY plane of the optical substrate.
   234. The method of any one of the preceding Embodiments, wherein the direction of the relative movement between the nozzle of the microvalving apparatus and the optical substrate is limited to the XY plane of the optical substrate.
   235. The method of any one of the preceding Embodiments, wherein, during the microvalving, the distance between the nozzle of the microvalving apparatus and the optical substrate varies by at least 0.5 mm, due to the curvature of the optical substrate.
   236. The method of any one of the preceding Embodiments, wherein, during the microvalving, the distance between the nozzle of the microvalving apparatus and the optical substrate varies by at least 1.0 mm, due to the curvature of the optical substrate.
   237. The method of any one of the preceding Embodiments, wherein, during the microvalving, the distance between the nozzle of the microvalving apparatus and the optical substrate varies by at least 2 mm, due to the curvature of the optical substrate.
   238. The method of any one of the preceding Embodiments, wherein, during the microvalving, the distance between the nozzle of the microvalving apparatus and the optical substrate varies by at least 3.5 mm, due to the curvature of the optical substrate.
   239. The method of any one of the preceding Embodiments, wherein, during the microvalving, the distance between the nozzle of the microvalving apparatus and the optical substrate varies within a range of 3.5 to 5 mm, due to the curvature of the optical substrate.
   240. The method of any one of the preceding Embodiments, wherein, during the microvalving, the distance between the nozzle of the microvalving apparatus and the optical substrate in uncontrolled.
   241. The method of any one of the preceding Embodiments, wherein, within the printed area, an average (mean) calculated thickness of dye on the optical substrate is at least 0.2 μm.
   242. The method of Embodiment 241, wherein the average calculated thickness of dye on the optical substrate is at least 0.3 μm.
   243. The method of Embodiment 241, wherein the average calculated thickness of dye on the optical substrate is at least 0.4 μm.
   244. The method of Embodiment 241, wherein the average calculated thickness of dye on the optical substrate is at least 0.5 μm.
   245. The method of any one of Embodiments 241 to 244, wherein the average calculated thickness of dye on the optical substrate is at most 2 μm.
   246. The method of Embodiment 245, wherein the average calculated thickness of dye on the optical substrate is at most 1.5 μm.
   247. The method of Embodiment 245, wherein the average calculated thickness of dye on the optical substrate is at most 1.2 μm.
   248. The method of Embodiment 245, wherein the average calculated thickness of dye on the optical substrate is at most 1.0 μm.
   249. The method of Embodiment 245, wherein the average calculated thickness of dye on the optical substrate is at most 0.9 μm.
   250. The method of Embodiment 245, wherein the average calculated thickness of dye on the optical substrate is at most 0.8 μm.
   251. The method of Embodiment 245, wherein the average calculated thickness of dye on the optical substrate is at most 0.7 μm.
   252. The method of Embodiment 245, wherein the average calculated thickness of dye on the optical substrate is at most 0.6 μm.
   253. The method of any one of the preceding Embodiments, wherein the treating of the wet layer to produce a dried dye-containing layer is performed after at most 3 of said wet layers have been microvalved.
   254. The method of any one of the preceding Embodiments, wherein the treating of the wet layer to produce a dried dye-containing layer is performed after at most 2 of said wet layers have been microvalved.
   255. The method of any one of the preceding Embodiments, wherein the treating of the wet layer to produce a dried dye-containing layer is performed after a single wet layer of said wet layer has been microvalved.
   256. The method of any one of Embodiments 1 to 252, wherein the optical construction has a single dye layer containing the dye.
   257. The method of any previous Embodiment, wherein, within the ink formulation, a first total concentration of the group consisting of tetrahydrofuran (THF), methyl ethyl ketone (MEK), and acetone, by weight, is at most 12%.
   258. The method of Embodiment 257, wherein the first total concentration is at most 8%.
   259. The method of Embodiment 257, wherein the first total concentration is at most 4%.
   260. The method of Embodiment 257, wherein the first total concentration is at most 1%.
   261. The method of any previous Embodiment, wherein a second total concentration (TC2) of the group consisting of glycerol, triacetin, propylene glycol, ethylene glycol, and polyethylene glycols, by weight, is at most 3%.
   262. The method of Embodiment 261, wherein TC2 is at most 2%.
   263. The method of Embodiment 261, wherein TC2 is at most 1%.
   264. The method of Embodiment 261, wherein TC2 is at most 0.5%.
   265. The method of any of Embodiments 77 to 81, wherein the surface treatment includes applying a primer to a first surface of the optical substrate to form a wet primer coating, and drying the wet primer coating to form the optical surface of the optical substrate.
   266. The method of any preceding Embodiment, wherein, during the microvalving, the distance between the nozzle of the microvalving apparatus and the optical substrate is uncontrolled.
   267. The method of any preceding Embodiment, wherein the optical substrate has a diameter of at least 40 mm.
   268. The method of any preceding Embodiment, wherein the optical substrate has a diameter of at least 50 mm.
   269. The method of any preceding Embodiment, wherein the optical substrate has a diameter of at least 60 mm.
   270. The method of any preceding Embodiment, wherein the optical substrate has a diameter of at least 70 mm.
   271. The method of any preceding Embodiment, wherein the optical substrate has a diameter of at least 80 mm.
   272. The method of any preceding Embodiment, wherein the optical substrate has a diameter of at most 90 mm.
   273. The method of any preceding Embodiment, wherein the optical substrate has a diameter within a range of 50 mm to 80 mm.
   274. The method of any preceding Embodiment, wherein the optical substrate is a lens blank.
   275. The method of Embodiment 274, wherein the lens blank is semi-finished.
   276. The method of Embodiment 274, wherein the lens blank is finished.
   277. The method of any preceding Embodiment, wherein the optical substrate is a lens (e.g., an edged lens).
   278. The method of any preceding Embodiment, further comprising mounting the optical substrate having the dried dye-containing layer into eyeglasses frames (e.g. as a lens thereof).
   279. The method of any preceding Embodiment, the method utilizing any feature or features of any of the ink formulations and properties disclosed herein.
   280. The method of any preceding Embodiment, the method utilizing any feature or features of the features provided in the system Embodiments hereinbelow.
   281. The method of any preceding Embodiment, the method utilizing any feature or features as described herein.

### Optical Construction Embodiments

1. An optical construction, as described herein.
2. An optical construction comprising any of the structural features disclosed in method Embodiments 1 to 281.
3. An optical construction comprising any of the structural features disclosed in system Embodiments 1 to 72.
4. The optical construction of any of Embodiments 1 to 3, wherein the optical construction is or includes an eyeglass lens.
5. Eyeglasses comprising an eyeglass frame and at least one eyeglass lens of Embodiment 4.

### System Embodiments

1. A coating system comprising:
(a) an ink-formulation-application station including microvalve apparatus configured to microvalve droplets of an ink-formulation onto a target surface of an optical substrate to form a wet layer on the target surface; and
(b) a drying and/or curing station configured to dry and/or cure the wet layer to produce a cured coating on the target surface.
   2. The system of Embodiment 1, further comprising:
(c) an optical-substrate transfer apparatus configured to transfer the optical substrate having the wet layer on the target surface thereof from the ink-formulation-application station to the drying and/or curing station.
   3. The system of Embodiment 1 or 2, wherein the optical-substrate-transfer apparatus includes at least one of a robotic arm, a gripper, a conveyer belt, and an elevator for raising or lowering an elevation of the optical substrate on the target surface thereof.
   4. The system of any previous Embodiment, further comprising a controller programmed or programmable to regulate the optical-substrate-transfer apparatus such that the transfer of the optical substrate is contingent upon a detection that the wet layer has been formed on the target surface of the optical substrate at the ink-formulation-application station.
   5. The system of any previous Embodiment, wherein the drying and/or curing station includes at least one of a heat lamp, an oven, and a UV-curing mechanism.
   6. The system of any previous Embodiment, wherein the drying and/or curing station includes an oven which: (i) is open when the optical substrate having the wet layer on the target surface thereof is transferred thereinto, and (ii) is closed, subsequent to transfer of the optical substrate to the oven, and remains closed during the drying and/or curing.
   7. The system of any previous Embodiment, comprising a primer application station configured to apply droplets of a primer formulation onto the target surface before microvalving ink-formulation thereupon.
   8. The system of Embodiment 7, wherein the primer application station includes a microvalve apparatus for applying drops of the primer formulation.
   9. The system of any previous Embodiment, further comprising at least one of: (i) a treatment station for increasing the surface energy of the target surface before application thereon of the primer or the ink formulation; and (ii) a cleaning station for subjecting the target surface to a cleaning process before microvalve-application thereon of the primer or the ink formulation.
   10. The system of Embodiment 9, further comprising the surface energy treatment station, said surface energy station including at least one of a corona-treatment-apparatus and a plasma-treatment apparatus.
   11. The system of any preceding Embodiment, wherein the ink-formulation-application station includes a reservoir of the ink formulation and is configured to microvalve, onto the target surface of the optical substrate, ink formulation stored in the reservoir.
   12. The system of any preceding Embodiment, wherein the system is further configured to apply, optionally by microvalving, at least one of a tint formulation and a photochromic formulation to the target surface of the optical substrate before the application thereon of the wet layer of the ink formulation.
   13. The system of any preceding Embodiment, wherein the system is devoid of dip coating apparatus.
   14. The system of any preceding Embodiment, wherein the system is devoid of spin coating apparatus.
   15. The system of any preceding Embodiment, including a controller configured or programmed to control the microvalving of the droplets of the formulation onto the target surface.
   16. The system of any one of the preceding Embodiments, wherein the target surface is curved.
   17. The system of any one of the preceding Embodiments, wherein the target surface has a SAG number of at least 0.5 mm.
   18. The system of any one of Embodiments 15 to 17, wherein the controller is configured or programmed to control the microvalving such that a ratio of a volume of formulation applied per unit of area of a two-dimensional projection of the target surface is constant.
   19. The system of any one of Embodiments 15 to 17, wherein the controller is configured or programmed to control the microvalving such that a ratio of a volume of formulation applied per unit of area of a two-dimensional projection of the target surface, within any subdivision of said two-dimensional projection having an area of 5% or more of an area of the projection, is within ±10%, or within ±5%, or within +2%, or within ±1% of a mean value of said ratio for all of said two-dimensional projection.
   20. The system of any one of Embodiments 15 to 19, wherein the controller is configured or programmed to generate the two-dimensional projection of the target surface, before the microvalving.
   21. The system of any one of Embodiments 15 to 20, wherein the controller is configured or programmed to calculate or select a ratio of the volume of formulation per unit of area of the two-dimensional projection of the target surface, before the microvalving.
   22. The system of Embodiment 21, wherein the controller is configured or programmed to control the microvalving such that a ratio of a volume of formulation applied per unit of area of a two-dimensional projection of the target surface, within any subdivision of said two-dimensional projection having an area of 5% or more of an area of the projection, is within +10%, or within ±5%, or within ±2%, or within ±1% of said calculated or selected ratio.
   23. The system of any preceding Embodiment, wherein the microvalving is such that a ratio of a mean volume of formulation applied per unit of area of the target surface in an edge portion thereof characterized by lying between 90% and 100% of a distance from a centroid of the target surface and a perimeter thereof, is between 0.60 and 0.96 times a maximum ratio of a volume of formulation applied per unit of area of the target surface.
   24. The system of any of Embodiments 1 to 22, wherein the microvalving is such that a ratio of a mean volume of formulation applied per unit of area of the target surface in an edge portion thereof characterized by lying between 90% and 100% of a distance from a centroid of the target surface and a perimeter thereof, is between 0.60 and 0.96 times a mean ratio of a volume of formulation applied per unit of area in a central area characterized by lying between 0% and 10% of a distance from said centroid of the target surface and said perimeter.
   25. The system of either one of Embodiments 23 or 24, wherein the SAG number of the target surface is at least 1 mm and at most 15 mm.
   26. The system of Embodiment 25, wherein the SAG number is at least 2 mm.
   27. The system of Embodiment 25, wherein the SAG number is at least 3.5 mm.
   28. The system of Embodiment 25, wherein the SAG number is at least 4.5 mm.
   29. The system of Embodiment 25, wherein the SAG number is at least 5 mm.
   30. The system of Embodiment 25, wherein the SAG number is at least 6 mm.
   31. The system of Embodiment 25, wherein the SAG number is at least 7 mm.
   32. The system of Embodiment 25, wherein the SAG number is at least 9 mm.
   33. The system of any of Embodiments 25 to 32, wherein the SAG number is at most 13.5 mm.
   34. The system of Embodiment 33, wherein the SAG number is at most 12 mm.
   35. The system of Embodiment 33, wherein the SAG number is at most 10.5 mm.
   36. The system of any of Embodiments 25 to 31, wherein the SAG number is at most 8 mm.
   37. The system of any one of Embodiments 23 to 36, wherein the ratio in the edge portion is between 0.6 and 0.9 times the maximum ratio.
   38. The system of any one of Embodiments 23 to 36, wherein the ratio in the edge portion is between 0.6 and 0.85 times the maximum ratio.
   39. The system of any one of Embodiments 23 to 36, wherein the ratio in the edge portion is between 0.8 and 0.96 times the ratio in the central area.
   40. The system of any one of Embodiments 23 to 36, wherein the ratio in the edge portion is between 0.9 and 0.96 times the ratio in the central area.
   41. The system of any one of Embodiments 13 to 22, wherein the SAG number of the target surface is between 9 mm and 13 mm, and the microvalving is such that a ratio of a volume of formulation applied per unit of area of the target surface near an edge thereof characterized by lying between 90% and 100% of a distance from a centroid of the target surface and a perimeter thereof, is between 0.62 and 0.85 times a maximum ratio of a volume of formulation applied per unit of area of the target surface.
   42. The system of any one of Embodiments 13 to 22, wherein the SAG number of the target surface is between 7 mm and 9 mm, and the microvalving is such that a ratio of a volume of formulation applied per unit of area of the target surface near an edge thereof characterized by lying between 90% and 100% of a distance from a centroid of the target surface and a perimeter thereof, is between 0.72 and 0.92 times a maximum ratio of a volume of formulation applied per unit of area of the target surface.
   43. The system of any one of Embodiments 13 to 22, wherein the SAG number of the target surface is between 5 mm and 7 mm, and the microvalving is such that a ratio of a volume of formulation applied per unit of area of the target surface near an edge thereof characterized by lying between 90% and 100% of a distance from a centroid of the target surface and a perimeter thereof, is between 0.82 and 0.96 times a maximum ratio of a volume of formulation applied per unit of area of the target surface.
   44. The system of any one of Embodiments 13 to 22, wherein the microvalving is such that a ratio of a mean volume of formulation applied per unit of area of the target surface at a given point on the target surface, is equal to a reduction factor times a maximum ratio of a volume of formulation applied per unit of area at any point on the target surface, said reduction factor being equal to a cosine of an acute angle formed between (i) a plane that is tangent to the target surface at said given point and (ii) a horizontal plane.
   45. The system of Embodiment 44, wherein the reduction factor at any point on a perimeter of the curved surface is between 0.63 and 0.96.
   46. The system of any one of Embodiments 13 to 45, wherein for any point on the target surface, a maximum acute angle formed between (i) a plane that is tangent to the target surface at said given point and (ii) a horizontal plane is between 10° and 40°.
   47. The system of any one of Embodiments 13 to 45, wherein for any point on the target surface, a maximum acute angle formed between (i) a plane that is tangent to the target surface at said given point and (ii) a horizontal plane is between 5° and 50°.
   48. The system of any one of Embodiments 13 to 45, wherein for any point on the target surface, a maximum acute angle formed between (i) a plane that is tangent to the target surface at said given point and (ii) a horizontal plane is between 15° and 40°.
   49. The system of any one of Embodiments 13 to 45, wherein for any point on the target surface, a maximum acute angle formed between (i) a plane that is tangent to the target surface at said given point and (ii) a horizontal plane is between 5° and 20°.
   50. The system of any one of the preceding Embodiments, wherein the system is configured to perform the microvalving without any relative vertical z-axis movement between the microvalve apparatus and the target surface.
   51. The system of any one of the preceding Embodiments, wherein the system is not configured to perform the microvalving while causing relative vertical z-axis movement between the microvalve apparatus and the target surface.
   52. The system of any one of the preceding Embodiments, wherein the system is not configured to perform the microvalving while causing relative vertical z-axis movement between the microvalve apparatus and the target surface.
   53. The system of any one of the preceding Embodiments, wherein the system is configured to perform the microvalving without any relative rotational movement on a horizontal x-y plane between the microvalve apparatus and the target surface during the forming of the wet layer.
   54. The system of any one of the preceding Embodiments, wherein the system is not configured to perform the microvalving while causing relative rotational movement on a horizontal x-y plane between the microvalve apparatus and the target surface during the forming of the wet layer.
   55. The system of Embodiment 54, wherein the ink-formulation-application station comprises a non-rotating optical-substrate holder.
   56. The system of any of preceding Embodiment, wherein the microvalve apparatus is piezo-actuated.
   57. The system of any of Embodiments 1 to 55, wherein the microvalve apparatus is electromagnetically actuated.
   58. The system of any of preceding Embodiment, wherein for any point on the target surface, an acute angle formed between (i) a plane that is tangent to the target surface at said given point and (ii) a horizontal plane, is an angle (α), wherein the maximum a on the target surface is αₘₐₓ, and wherein αₘₐₓ is at least 5°.
   59. The system of Embodiment 58, wherein αₘₐₓ is at least 10°.
   60. The system of Embodiment 58, wherein αₘₐₓ is at least 15°.
   61. The system of Embodiment 58, wherein αₘₐₓ is at least 20°.
   62. The system of Embodiment 58, wherein αₘₐₓ is at least 25°.
   63. The system of Embodiment 58, wherein αₘₐₓ is at least 30°.
   64. The system of any one of claims 2-4, wherein αₘₐₓ is at most 50°.
   65. The system of any one of Embodiments 58 to 64, wherein αₘₐₓ is within a range of 30-40°, and wherein R_{D1} is at most 0.90, or within a range of 0.62 to 0.90.
   66. The system of any one of Embodiments 58 to 64, wherein αₘₐₓ is within a range of 19-27°, and wherein R_{D1} is at most 0.93, or within a range of 0.85 to 0.93.
   67. The system of any one of Embodiments 58 to 64, wherein αₘₐₓ is within a range of 15-20°, and wherein R_{D1} is at most 0.97 or within a range of 0.90 to 0.97.
   68. The system of any preceding Embodiment, wherein the liquid ink formulation is the ink formulation of any one of formulation Embodiments 1 to 231.
   69. The system of any preceding Embodiment, the system comprising any feature or features of the ink formulation of any one of formulation Embodiments 1 to 231.
   70. The system of any preceding Embodiment, the system comprising any feature or features of the features provided in the formulation Embodiments.
   71. The system of any preceding Embodiment, the system comprising any feature or features of the features provided in the method Embodiments hereinabove.
   72. The system of any preceding Embodiment, the system comprising any feature or features as described herein.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A coating system comprising:
(a) an ink-formulation-application station including microvalve apparatus configured to microvalve droplets of an ink formulation onto a target surface of an optical substrate to form a wet layer on the target surface;
(b) a drying and/or curing station configured to dry and/or cure, on the target surface, the wet layer to produce a cured coating thereof,
(c) an optical-substrate transfer apparatus configured to transfer the optical substrate having the wet layer on the target surface thereof from the ink-formulation-application station to the drying and/or curing station; and
(d) a treatment station for increasing the surface energy of the target surface before application thereon of a wet layer; and
(e) a controller configured or programmed to control the microvalving of the droplets of the formulation onto the target surface;
wherein the microvalving is such that a dimensionless ink coverage ratio (R_{D1}) defined by a ratio of a mean volume of formulation applied per unit of area of the target surface in an edge portion thereof characterized by lying between 90% and 100% of a distance from a centroid of the target surface and a perimeter thereof, is between 0.60 and 0.96 times a mean ratio of a volume of formulation applied per unit of area in a central area characterized by lying between 0% and 10% of a distance from said centroid of the target surface and said perimeter.

2. The system of claim 1, wherein for any point on the target surface, an acute angle formed between (i) a plane that is tangent to the target surface at said given point and (ii) a horizontal plane, is an angle (α), wherein the maximum a on the target surface is αₘₐₓ, and wherein αₘₐₓ is at least 5°.

3. The system of claim 2, wherein αₘₐₓ is at least 10°.

4. The system of claim 2, wherein αₘₐₓ is at least 15°.

5. The system of any one of claims 2-4, wherein αₘₐₓ is at most 50°.

6. The system of any one of claims 2-4, wherein αₘₐₓ is within a range of 30-40°, and wherein R_{D1} is at most 0.90, or within a range of 0.62 to 0.90.

7. The system of any one of claims 2-4, wherein αₘₐₓ is within a range of 19-27°, and wherein R_{D1} is at most 0.93, or within a range of 0.85 to 0.93.

8. The system of any one of claims 2-4, wherein αₘₐₓ is within a range of 15-20°, and wherein R_{D1} is at most 0.97 or within a range of 0.90 to 0.97.

9. The system of any one of claims 1-8, wherein the controller is configured or programmed to control the microvalving such that a ratio of a volume of formulation applied per unit of area of a two-dimensional projection of the target surface, within any subdivision of said two-dimensional projection having an area of 5% or more of an area of the projection, is within ±10% of said calculated or selected ratio.

10. The system of any one of claims 1-9, wherein said treatment station is further for increasing the surface energy of a top surface of said fully cured coating.

11. The system of any one of claims 2-10, wherein the system is devoid of dip coating and spin coating apparatus.

12. The system of any one of claims 1-11, wherein the system is not configured to perform the microvalving while causing relative rotational movement on a horizontal x-y plane between the microvalve apparatus and the target surface during the forming of the wet layer.

13. The system of claim 12, wherein the ink-formulation-application station comprises a non-rotating optical-substrate holder.

14. A method of producing an optical construction on an optical substrate, the method comprising:
(a) providing the system of any one of claims 1 to 13;
(b) microvalving ink drops of an ink formulation containing at least one dissolved dye onto an optical surface of the optical substrate, to form a wet layer; and
(c) treating the wet layer to produce a dried or cured dye-containing layer on said optical surface.

15. The method of claim 14, further comprising, prior to said microvalving, applying a primer to a first surface of the optical substrate to form a wet primer coating, and fully curing the wet primer coating to form the optical surface of the optical substrate.

16. The method of claim 15, wherein the cured primer coating has a non-tacky upper surface.

17. The method of claim 15 or 16, further comprising applying a surface energy treatment to the top surface of the fully-cured primer coating, prior to said microvalving.

18. The method of any one of claims 14 to 17, further comprising, after treating the wet layer to produce a dried dye-containing layer on the optical surface, applying a wet overcoat layer on top of the outer or exposed face of the dried dye containing layer.

19. The method of any one of claims 14 to 18, wherein said liquid ink formulation comprises
(a) a resin;
(b) a dye;
(c) a solvent system including a very low vapor-pressure solvent (LLevap) and at least one of a high vapor-pressure solvent (Hevap) and a very high vapor-pressure solvent (HHevap);
wherein the resin, the photochromic dye, and the non-volatile liquid softening agent are dissolved within the solvent system, forming a single liquid phase;
wherein a first weight ratio of the resin to the dye is at least 0.5:1;
wherein the non-volatile content of the ink formulation is within a range of 2.5 to 15%;
wherein a first solvent weight ratio of Hevap, HHevap, and LLevap to the total amount of solvent Ts within the ink formulation,
$$( Hevap + HHevap + LLevap ) / Ts$$
is at least 0.7;
and wherein a solvent weight ratio of LLevap to a total of Hevap and HHevap, is within a range of 0.15:1 to 2.2:1.

20. The method of claim 19, wherein LLevap has a relative evaporation rate of at most 0.04.
